(19) United States
(12) Patent Application Publication
(10) Pub. No.: US 2015/0254635 A1
(43) Pub. Date: Sep. 10, 2015

(54) LIMITING THE USE OF A TOKEN BASED ON A USER LOCATION

(71) Applicant: BANK OF AMERICA CORPORATION, Charlotte, NC (US)

(72) Inventors: Laura Corinne Bondesen, Charlotte, NC (US); Jason P. Blackhurst, Charlotte, NC (US); Scott Lee Harkey, Concord, NC (US); William Blakely Belchee, Charlotte, NC (US); Tammy L. Brunswig, Fort Mill, SC (US)

(73) Assignee: BANK OF AMERICA CORPORATION, Charlotte, NC (US)

(21) Appl. No.: 14/196,809

(22) Filed: Mar. 4, 2014

(51) Int. Cl. G06Q 20/32; G06Q 20/36

(52) U.S. Cl. CPC G06Q 20/3224; G06Q 20/36

(57) ABSTRACT

Systems, methods, and computer program products for limiting the use of a token based on a user location are provided. Embodiments of the invention involve a memory device; and a processing device operatively coupled to the memory device, wherein the processing device is configured to execute computer-readable program code to: receive a payment authorization request associated with a transaction from a merchant, wherein the payment authorization request comprises a transaction information, wherein the transaction is conducted using a token between a user and a merchant; determine a response associated with the payment authorization request based on one or more limits, wherein the one or more limits are based on at least a user location; and transmit the response associated with the payment authorization request to the merchant.

### FIELD

The present invention relates in general to payment instruments associated with conducting a transaction between a user and a merchant.

### BACKGROUND

Tokens may be used as a replacement for sensitive account information such as a user's account number, debit card, credit card, or the like. There is a need for a system to limit the use of a token by applying one or more limits on the utilization of the token based on at least a user preference.

### BRIEF SUMMARY OF THE INVENTION

Embodiments of the present invention address the above needs and/or achieve other advantages by providing apparatuses (e.g., a system, computer program product, and/or other device) and methods that limits the use of a token based on a user location.

Embodiments of the invention comprise systems, computer program products, and methods for limiting the use of a token based on a user location. One embodiment of the invention enables a system to receive a payment authorization request associated with the financial transaction from a merchant, wherein the payment authorization request comprises transaction information associated with the financial transaction, wherein the financial transaction is conducted using the token between the user and the merchant, wherein the payment authorization request comprises the user location associated with the financial transaction; determine a response associated with the payment authorization request, wherein the response is based on the one or more limits associated with the token used to conduct the financial transaction, wherein the one or more limits are based on at least a geographic limit associated with the use of the token; authorize a payment associated with the payment transaction request when the transaction information meets the one or more limits, including when at least the user location associated with the financial transaction meets the geographic limit associated with the use of the token; deny a payment associated with the payment transaction request when the transaction information fails to meet the one or more limits, including when at least the user location associated with the financial transaction fails to meet the geographic limit associated with the use of the token; and transmit the response associated with the payment authorization request to the merchant.

In some embodiments, the geographic limit comprises a boundary defined by a geographic radius associated with a location.

In some other embodiments, wherein the geographic limits is based on a transportation route.

In alternative embodiments, the user location is determined from a location of a payment device associated with the token at a same or similar time stamp associated with the transaction, wherein the location of the payment device is an indication of a location of the user.

In some embodiments, the user location is determined from the transaction information.

In some other embodiments, the token is associated with the financial account is associated with two or more financial accounts associated with the user.

In alternative embodiments, the system enables a user selection of the two or more financial institution accounts associated with the token.

In alternative embodiments, the token is associated with one or more digital wallets on one or more payment devices associated with a plurality of users.

In some embodiments, the token is a shared token and the user is part of a collaborative group of users, and wherein the shared token is used by the collaborative group of users.

In some other embodiments, the token is an individual token for the user in a collaborative group of users.

In alternative embodiments, the one or more limits are further based on at least a time period, wherein the response is based on whether a time stamp associated with the transaction is within the time period.

In some other embodiments, the one or more limits further comprises a number of transactions, a transaction amount, a merchant, a merchant type, a product, a product type, one or more product categories, or an account limit.

In one aspect, a computer program product for limiting the use of a token based on a user location, the computer program product is presented, the computer program product comprising at least one non-transitory computer-readable medium having a computer-readable program code portions embodied therein, the computer-readable program code portions comprising: an executable portion configured for receiving a payment authorization request associated with the financial transaction from a merchant, wherein the payment authorization request comprises transaction information associated with the financial transaction, wherein the financial transaction is conducted using the token between the user and the merchant, wherein the payment authorization request comprises the user location associated with the financial transaction; an executable portion configured for determining a response associated with the payment authorization request, wherein the response is based on the one or more limits associated with the token used to conduct the financial transaction, wherein the one or more limits are based on at least a geographic limit associated with a use of the token; an executable portion configured for authorizing a payment associated with the payment transaction request when the transaction information meets the one or more limits, including when at least the user location associated with the financial transaction meets the geographic limit associated with the use of the token; an executable portion configured for denying a payment associated with the payment transaction request when the transaction information fails to meet the one or more limits, including when at least the user location associated with the financial transaction fails to meet the geographic limit associated with the use of the token; and an executable portion configured for transmitting the response associated with the payment authorization request to the merchant.

In alternative embodiments, the geographic limit comprises a boundary defined by a geographic radius associated with a location.

In some embodiments, the geographic limit is based on a transportation route.

In alternative embodiments, the user location is determined from a location of a payment device associated with the token at a same or similar time stamp associated with the transaction, wherein the location of the payment device is an indication of a location of the user.

In alternative embodiments, the user location is determined from the transaction information.

In some embodiments, the token is associated with one or more digital wallets on one or more payment devices associated with a plurality of users, and wherein the token is a shared token and the user is part of a collaborative group of users, and wherein the shared token is used by the collaborative group of users.

In other embodiments, the token is an individual token for the user in a collaborative group of users.

In one aspect, the a method for limiting the use of a token based on a user location is presented, the method comprising: receiving, using a computing device processor, a payment authorization request associated with the financial transaction from a merchant, wherein the payment authorization request comprises transaction information associated with the financial transaction, wherein the financial transaction is conducted using the token between the user and the merchant, wherein the payment authorization request comprises the user location associated with the financial transaction; determining, using a computing device processor, a response associated with the payment authorization request, wherein the response is based on the one or more limits associated with the token used to conduct the financial transaction, wherein the one or more limits are based on at least a geographic limit associated with a use of the token; authorizing, using a computing device processor, a payment associated with the payment transaction request when the transaction information meets the one or more limits, including when at least the user location associated with the financial transaction meets the geographic limit associated with the use of the token; denying, using a computing device processor, a payment associated with the payment transaction request when the transaction information fails to meet the one or more limits, including when at least the user location associated with the financial transaction fails to meet the geographic limit associated with the use of the token; and transmitting, using a computing device processor, the response associated with the payment authorization request to the merchant.

### BRIEF DESCRIPTION OF THE DRAWINGS

Having thus described embodiments of the invention in general terms, reference will now be made to the accompanying drawings, wherein:

FIG. 1 illustrates a high level process flow for a entering into a transaction using a token, in accordance with one embodiment of the present invention.

FIG. 2 illustrates a high level process flow for a entering into a transaction using a token, in accordance with one embodiment of the present invention.

FIG. 3 illustrates a high level process flow for a entering into a transaction using a token, in accordance with one embodiment of the present invention.

FIG. 4 illustrates a token collaboration process flow, in accordance with one embodiment of the present invention.

FIG. 5A illustrates a process flow for applying one or more limits to a token, in accordance with one embodiment of the present invention.

FIG. 5B illustrates a process flow for authorizing payment for a transaction conducted using a token for a specified user, in accordance with one embodiment of the present invention.

FIG. 6A illustrates a process flow for applying geographic limits on a token, in accordance with one embodiment of the present invention, in accordance with one embodiment of the present invention.

FIG. 6B illustrates a process flow for limiting the use of a token based on a user location, in accordance with one embodiment of the present invention.

FIG. 7 illustrates a token system environment, in accordance with one embodiment of the present invention.

### DETAILED DESCRIPTION OF THE INVENTION

The present invention relates to tokenization, which is generally described in the area of financial transactions as utilizing a “token” (e.g., an alias, substitute, surrogate, or other like identifier) as a replacement for sensitive account information, and in particular account numbers. As such, tokens or portions of tokens may be used as a stand in for a user account number, user name, pin number, routing information related to the financial institution associated with the account, security code, or other like information relating to the user account. The one or more tokens may then be utilized as a payment instrument to complete a transaction. The one or more tokens may be associated with one or more payment devices directly or within one or more digital wallets associated with the payment devices. In other embodiments, the tokens may be associated with electronic transactions that are made over the Internet instead of using a physical payment device. Utilizing a token as a payment instrument instead of actual account information, and specifically an account number, improves security, and provides flexibility and convenience in controlling the transactions, controlling accounts used for the transactions, and sharing transactions between various users.

Tokens may be single-use instruments or multi-use instruments depending on the types of controls (e.g., limits) initiated for the token, and the transactions in which the token is used as a payment instrument. Single-use tokens may be utilized once, and thereafter disappear, are replaced, or are erased, while multi-use tokens may be utilized more than once before they disappear, are replaced, or are erased.

Tokens may be 16-digit numbers (e.g., like credit, debit, or other like account numbers), may be numbers that are less than 16-digits, or may contain a combination of numbers, symbols, letters, or the like, and be more than, less than, or equal to 16-characters. In some embodiments, the tokens may have to be 16-characters or less in order to be compatible with the standard processing systems between merchants, acquiring financial institutions (e.g., merchant financial institution), card association networks (e.g., card processing companies), issuing financial institutions (e.g., user financial institution), or the like, which are used to request authorization, and approve or deny transactions entered into between a merchant (e.g., a specific business or individual user) and a user. In other embodiments of the invention, the tokens may be other types of electronic information (e.g., pictures, codes, or the like) that could be used to enter into a transaction instead of, or in addition to, using a string of characters (e.g., numbered character strings, alphanumeric character strings, symbolic character strings, combinations thereof, or the like).

A user may have one or more digital wallets on the user's payment device. The digital wallets may be associated specifically with the user's financial institution, or in other embodiments may be associated with a specific merchant, group of merchants, or other third parties. The user may associate one or more user accounts (e.g., from the same institution or from multiple institutions) with the one or more digital wallets. In some embodiments, instead of the digital wallet storing the specific account number associated with the user account, the digital wallet may store a token or allow access to a token (e.g., provide a link or information that directs a system to a location of a token), in order to represent the specific account number during a transaction. In other embodiments of the invention, the digital wallet may store some or all of the user account information (e.g., account number, user name, pin number, or the like), including the user account number, but presents the one or more tokens instead of the user account information when entering into a transaction with a merchant. The merchant may be a business, a person that is selling a good or service (hereinafter “product”), or any other institution or individual with which the user is entering into a transaction.

The digital wallet may be utilized in a number of different ways. For example, the digital wallet may be a device digital wallet, a cloud digital wallet, an e-commerce digital wallet, or another type of digital wallet. In the case of a device digital wallet the tokens are actually stored on the payment device. When the device digital wallet is used in a transaction the token stored on the device is used to enter into the transaction with the merchant. With respect to a cloud digital wallet the device does not store the token, but instead the token is stored in the cloud of the provider of the digital wallet (or another third party). When the user enters into a transaction with a merchant, transaction information is collected and provided to the owner of the cloud to determine the token, and thus, how the transaction should be processed. In the case of an e-commerce digital wallet, a transaction is entered into over the Internet and not through a point of sale terminal. As was the case with the cloud digital wallet, when entering into a transaction with the merchant over the Internet the transaction information may be captured and transferred to the wallet provider (e.g., in some embodiments this may be the merchant or another third party that stores the token), and the transaction may be processed accordingly.

Specific tokens, in some embodiments, may be tied to a single user account, but in other embodiments, may be tied to multiple user accounts, as will be described throughout this application. In some embodiments a single tokens could represent multiple accounts, such that when entering into a transaction the user may select the token (or digital wallet associated with the token) and select one of the one or more accounts associated with the token in order to allocate the transaction to a specific account. In still other embodiments, after selection of the token by the user the system may determine the best account associated with the token to use during the transaction (e.g., most cash back, most rewards points, best discount, or the like). In addition, the tokens may be associated with a specific digital wallet or multiple digital wallets as desired by the institutions or users.

Moreover, the tokens themselves, or the user accounts, individual users, digital wallets, or the like associated with the tokens, may have limitations that limit the transactions that the users may enter into using the tokens. The limitations may include, limiting the transactions of the user to a single merchant, a group of multiple merchants, merchant categories, single products, a group a products, product categories, transaction amounts, transaction numbers, geographic locations, or other like limits as is described herein.

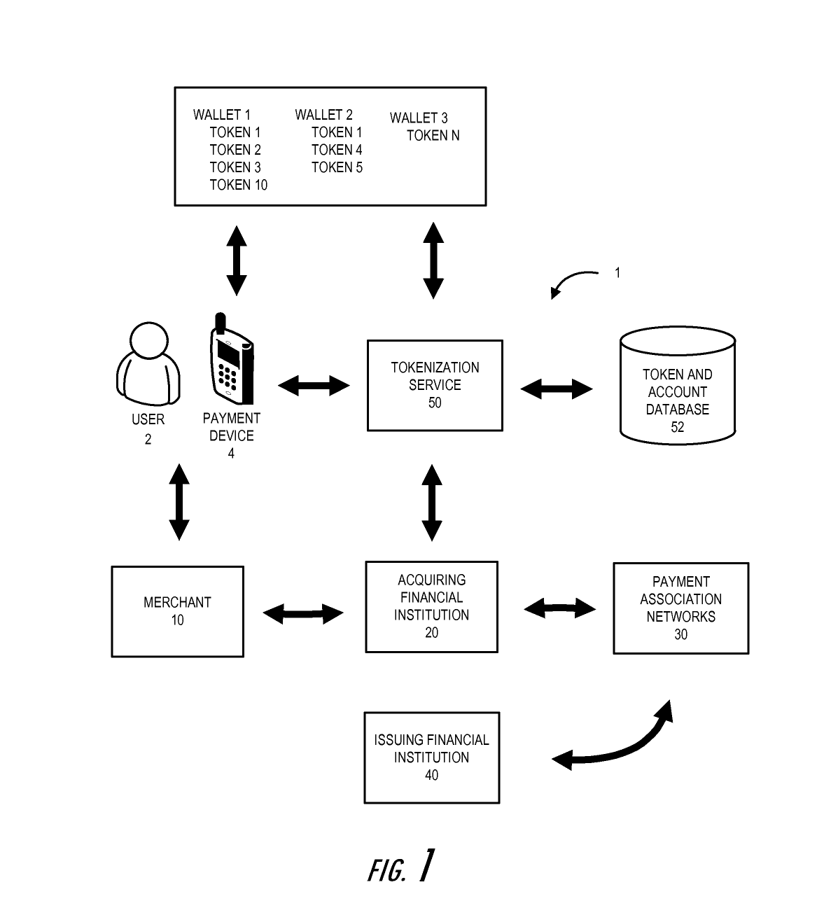

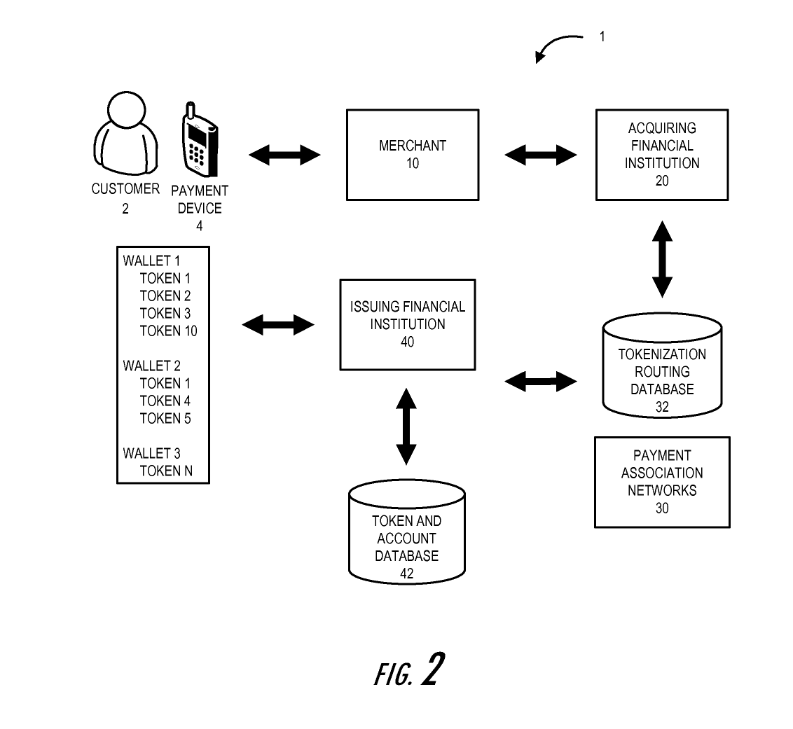

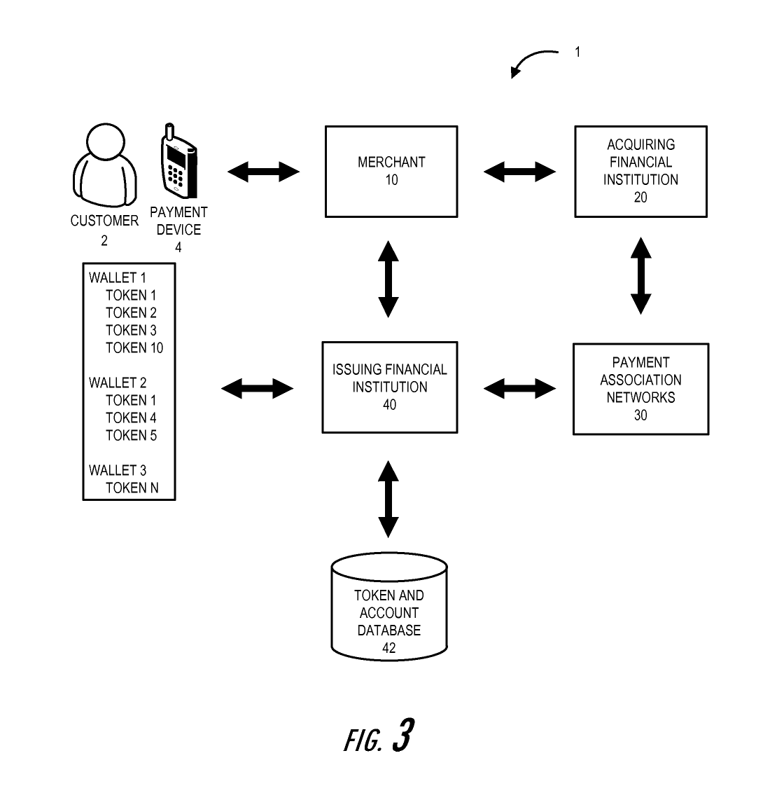

FIGS. 1 through 3 illustrate a number of different ways that the user 2 may use one or more tokens in order to enter into a transaction, as well as how the parties associated with the transaction may process the transaction. FIG. 1, illustrates one embodiment of a token system process 1, wherein the token system process 1 is used in association with a tokenization service 50. The tokenization service 50 may be provided by a third-party institution, the user's financial institution, or another institution involved in a transaction payment process. As illustrated in FIG. 1 (as well as in FIGS. 2 and 3), a user 2 may utilize a payment device 4 (or in other embodiments a payment instrument over the Internet) to enter into a transaction. FIG. 1 illustrates the payment device 4 as a mobile device, such as a smartphone, personal digital assistant, or other like mobile payment device. Other types of payment devices 4 may be used to make payments, such as but not limited to an electronic payment card, key fob, a wearable payment device (e.g., watch, glasses, or the like), or other like payment devices 4. As such, when using a payment device 4 the transaction may be made between the point of sale (POS) and the payment device 4 by scanning information from the payment device 4, using near field communication (NFC) between the POS and the payment device 4, using wireless communication between the POS and the payment device 4, or using another other type of communication between the POS and the payment device 4. When entering into an e-commerce transaction over the Internet, for example using the payment device 4 or another device without a POS, a payment instrument (e.g., a payment application that stores the token) may be used to enter into the transaction. The payment instrument may be the same as the token or digital wallet associated with the payment device 4, except they are not associated with specific payment device. For example, the token or digital wallet may be associated with a payment application that can be used regardless the device being used to enter into the transaction over the Internet.

The token can be associated directly with the payment device 4, or otherwise, through one or more digital wallets associated with the payment device 4. For example, the token may be stored on one or more payment devices 4 directly, and as such any transaction entered into by the user 2 with the one or more payment devices 4 may utilize the token. Alternatively, the payment device 4 may have one or more digital wallets stored on the payment device 4 that allow the user 2 to store one or more user account numbers, or tokens associated with the user account numbers, on the one or more digital wallets. The user may select a digital wallet or account within the digital wallet in order to enter into a transaction using a specific type of customer account. As such, the digital wallets may be associated with the user's issuing financial institutions 40, other financial institutions, merchants 10 with which the user enters into transactions, or a third party institutions that facilitates transactions between users 2 and merchants 10.

As illustrated in FIG. 1, a tokenization service 50 may be available for the user 2 to use during transactions. As such, before entering into a transaction, the user 2 may generate (e.g., create, request, or the like) a token in order to make a payment using the tokenization service 50, and in response the tokenization service 50 provides a token to the user and stores an association between the token and the user account number in a secure token and account database 52. The token may be stored in the user's payment device 4 (e.g., on the digital wallet) or stored on the cloud or other service through the tokenization service 50. The tokenization service 50 may also store limits (e.g., geographic limits, transaction amount limits, merchant limits, product limits, any other limit described herein, or the like) associated with the token that may limit the transactions in which the user 2 may enter. The limits may be placed on the token by the user 2, or another entity (e.g., client, administrator, person, company, or the like) responsible for the transactions entered into by the user 2 using the account associated with the token. The generation of the token may occur at the time of the transaction or well in advance of the transaction, as a one-time use token or multi-use token.

After or during creation of the token the user 2 enters into a transaction with a merchant 10 using the payment device 4 (or payment instrument over the Internet). In some embodiments the user 2 may use the payment device 4 by itself, or specifically select a digital wallet or user account stored within the digital wallet, to use in order to enter into the transaction. The token associated with payment device, digital wallet, or user account within the wallet is presented to the merchant 10 as payment in lieu of the actual user account number and/or other user account information. The merchant 10 receives the token, multiple tokens, and/or additional user account information for the transaction. The merchant 10 may or may not know that the token being presented for the transaction is a substitute for a user account number or other user account information. The merchant also captures transaction information (e.g., merchant, merchant location, transaction amount, product, or the like) related to the transaction in which the user 2 is entering with the merchant 10.

The merchant 10 submits the token (as well as any user account information not substituted by a token) and the transaction information for authorization along the normal processing channels (also described as processing rails), which are normally used to process a transaction made by the user 2 using a user account number. In one embodiment of the invention the acquiring financial institution 20, or any other institution used to process transactions from the merchant 10, receives the token, user account information, and transaction information from the merchant 10. The acquiring financial institution 20 identifies the token as being associated with a particular tokenization service 50 through the token itself or user account information associated with the token. For example, the identification of the tokenization service 50 may be made through a sub-set of characters associated with the token, a routing number associated with the token, other information associated with the token (e.g., tokenization service name), or the like. The acquiring financial institution 20 may communicate with the tokenization service 50 in order to determine the user account number associated with the token. The tokenization service 50 may receive the token and transaction data from the acquiring financial institution 20, and in response, provide the acquiring financial institution 20 the user account number associated with the token as well as other user information that may be needed to complete the transaction (e.g., user name, issuing financial institution routing number, user account number security codes, pin number, or the like). In other embodiments, if limits have been placed on the token, the tokenization service 50 may determine whether or not the transaction information meets the limits and either allows or denies the transaction (e.g., provides the user account number or fails to provide the user account number). The embodiment being described occurs when the token is actually stored on the payment device 4. In other embodiments, for example, when the actual token is stored in a cloud the payment device 4 may only store a link to the token or other token information that allows the merchant 10 or acquiring financial institution to acquire the token from a stored cloud location.

If the acquiring financial institution 20 receives the user account number from the tokenization service 50 (e.g., the tokenization service indicates that the transaction meets the limits), then the acquiring financial institution 20 thereafter sends the user account number, the other user information, and the transaction information directly to the issuing financial institution 40, or otherwise indirectly through the card association networks 30. The issuing financial institution 40 determines if the user 2 has the funds available to enter into the transaction, and if the transaction meets other limits on the user account, and responds with approval or denial of the transaction. The approval runs back through the processing channels until the acquiring financial institution 20 provides approval or denial of the transaction to the merchant 10 and the transaction between the merchant 10 and the user 2 is completed. After the transaction is completed the token may be deleted, erased, or the like if it is a single-use token, or stored for further use if it is a multi-use token.

Instead of the process described above, in which the acquiring financial institution 20 requests the token from the tokenization service 50, in some embodiments the tokenization service 50 may receive the transaction request and transaction information from the merchant 10 or acquiring financial institution 20. Instead of providing the account number to the acquiring financial institution 20, the tokenization service 50 may send the transaction request and transaction information to the issuing financial institution 40 directly, or indirectly through the payment association networks 30.

The embodiment illustrated in FIG. 1 prevents the user account number and other user information from being presented to the merchant 10; however, the tokenization service 50, acquiring financial institution 20, the card association networks 30, and the issuing financial institution 40 may all utilize the actual user account number and other user information to complete the transaction.

FIG. 2 illustrates another embodiment of a token system process 1, in which the user 2 may utilize a payment device 4 (or payment instrument over the Internet) to enter into transactions with merchants 10 utilizing tokens instead of user account numbers. As illustrated in FIG. 2, the user may have one or more tokens, which may be associated with the payment device 4, one or more digital wallets within the payment device 4, or one or more user accounts associated with the digital wallets. The one or more tokens may be stored in the user's payment device 4 (or on the digital wallet), or stored on a cloud or other service through the issuing financial institution 40 or another institution. The user 2 may set up the digital wallet by communicating with the issuing financial institution 40 (e.g., the user's financial institution) to request a token for the payment device, either for the device itself, or for one or more digital wallets or one or more user accounts stored on the payment device. As previously discussed, a wallet may be specifically associated with a particular merchant (e.g., received from the merchant 10) and include one or more tokens provided by the issuing financial institution 40 directly (or through the merchant as described with respect to FIG. 3). In other embodiments, the issuing financial institution 40 may create the digital wallet for the user 2 (e.g., through a wallet created for a business client or retail client associated with the user 2) and include one or more tokens for various types of transactions, products, or the like. The issuing financial institution 40 may store the tokens, the associated user account information (e.g., including the user account number), and any limits on the use of the tokens, as was previously described with respect to the tokenization service 50 in FIG. 1. In one embodiment the tokens may include user account information or routing information within the token or tied to the token, which allows the merchants 10 and other institutions in the payment processing systems to route the token and the transaction information to the proper institutions for processing. In other embodiments a tokenization routing database 32 may be utilized to determine where to route a transaction using a token, as described in further detail later.

The user 2 may enter into a transaction with the merchant 10 using a payment device 4 (or a payment instrument through the Internet). In one embodiment the user 2 may enter into the transaction with a token associated with the payment device 4 itself (or a payment instrument through the Internet). In other embodiments, a specific digital wallet and/or a specific account within the digital wallet may be selected for a particular merchant with whom the user 2 wants to enter into a transaction. For example, the user 2 may select “wallet 1” to enter into a transaction with “merchant 1” and “token 1” to utilize a specific account. The merchant 10 identifies the token, and sends the token and the transaction information to the acquiring financial institution 20. If the token has routing information the acquiring financial institution 20 may route the token and transaction data to the issuing financial institution 40 directly or through the card association networks 30. In situations where the token does not have associated routing information, the acquiring financial institution 20 may utilize a tokenization routing database 32 that stores tokens or groups of tokens and indicates to which issuing financial institutions 40 the tokens should be routed. One or more of the acquiring financial institutions 20, the card association networks 30, and/or the issuing financial institutions 40 may control the tokenization routing database in order to assign and manage routing instructions for tokenization across the payment processing industry. The tokenization routing database 32 may be populated with the tokens and the corresponding issuing financial institutions 40 to which transactions associated with the tokens should be routed. However, in some embodiments no customer account information would be stored in this tokenization routing database 32, only the instructions for routing particular tokens may be stored.

Once the token and transaction details are routed to the issuing financial institution 40, the issuing financial institution 20 determines the user account associated with the token through the use of the token account database 42. The financial institution determines if the funds are available in the user account for the transaction and if the transaction information meets other limits by comparing the transaction information with the limits associated with the token, the user account associated with the token, or other limits described herein. If the transaction meets the limits associated with the token or user account, then the issuing financial institution 20 allows the transaction. If the transaction information does not meet one or more of the limits, then the issuing financial institution 20 denies the transaction. The issuing financial institution sends a notification of the approval or denial of the transaction back along the channels of the transaction processing system to the merchant 10, which either allows or denies the transaction.

The embodiment illustrated in FIG. 2 allows the user and the financial institution to shield the user's account number and other user information from all of the entities in the payment processing system because the merchant 10, acquiring merchant bank 20, payment association networks 30, or other institutions in the payment processing system only use the token and/or other shielded user information to process the transaction. Only the issuing financial institution 40 has the actual account number of the user 2.

FIG. 3 illustrates another embodiment of the token system process 1, in which the user 2 may utilize a payment device 4 (or payment instrument over the Internet) to enter into transactions with a merchant 10 utilizing a token instead of a user account number and/or other user account information. As illustrated in FIG. 3, the user 2 may have one or more tokens associated with the payment device 2, the one or more digital wallets, or one or more user accounts within the digital wallets. The one or more tokens may be stored in the user's payment device 4 (or within the digital wallet), or stored on a cloud or other service through the issuing financial institution 40 or another institution. The user 2 may set up the digital wallet by communicating with the issuing financial institution 40 (e.g., the user's financial institution) and/or the merchant 10 to request a token for the payment device 4, either for the payment device 4 itself, for the one or more digital wallets stored on the payment device 4, or for user accounts within the digital wallet. The financial institution 40 may have a dedicated group of tokens that are associated with a specific merchant, and as such the merchant 10 and the issuing financial institution 40 may communicate with each other to provide one or more tokens to the user 2 that may be specifically associated with the merchant 10. For example, the issuing financial institution may provide a set of tokens to “merchant 1” to associate with “wallet 1” that may be used by one or more users 2. As such “Token 10” may be associated with “wallet 1” and be specified only for use for transactions with “merchant 1.”

The merchant 10 may provide the specific tokens from the financial institution 40 to the user 2, while the financial institution 40 may store the user account information with the token provided to the user 2. The financial institution may communicate directly with the user 2, or through the merchant 10 in some embodiments, in order to associate the token with the user 2. Since the merchant 10 provides, or is at least notified by the financial institution 40, that a specific token, or groups of tokens, are associated with a specific issuing financial institution 40, then the merchant 10 may associate routing information and transaction information with the token when the user 2 enters into a transaction with the merchant 10 using the token.

The merchant 10 passes the token (and potentially other user account information), routing information, and transaction information to the acquiring financial institution 20 using the traditional payment processing channels. The acquiring financial institution 20, in turn, passes the token (and potentially other user account information) and transaction information to the issuing financial institution 40 directly, or indirectly through the payment association networks 30 using the routing information. The issuing financial institution 40 accesses the token and account database 42 to identify the user account associated with the token and determines if the transaction information violates any limits associated with the token or the user account. The issuing financial institution 40 then either approves or denies the transaction and sends the approval or denial notification back through the payment processing system channels to the merchant 10, which then notifies the user 2 that the transaction is allowed or denied.

As is the case with the token system process 1 in FIG. 2, the token system process 1 in FIG. 3 allows the user 2 and the financial institution 40 to shield the user's account number and other user information from all of the entities in the payment processing system because the merchant 10, acquiring merchant bank 20, payment association networks 30, or other institutions in the payment processing system only use the token and/or other shielded user information to process the transaction. Only the issuing financial institution 40 has the actual account number of the user 2.

The embodiments of the invention illustrated in FIGS. 1 through 3 are only example embodiments of the invention, and as such it should be understood that combinations of these embodiments, or other embodiments not specifically described herein may be utilized in order to process transactions between a user 2 and merchant 10 using one or more tokens as a substitute for user account numbers or other user account information, such that the merchant 10, or other institutions in the payment processing system do not have access to the actual user accounts or account information.

As briefly discussed above, if the issuing financial institution 40 creates the digital wallet not only does the issuing financial institution 40 receive transaction information along the normal processing channels, but the financial institution 50 may also receive additional transaction information from the user 2 through the digital wallet using the application program interfaces (APIs) or other applications created for the digital wallet. For example, geographic location information of the user 2, dates and times, product information, merchant information, or any other information may be transmitted to the issuing financial institution 40 through the APIs or other applications to the extent that this information is not already provided through the normal transaction processing channels. This additional transaction information may assist in determining if the transactions meet or violate limits associated with the tokens, user accounts, digital wallets, or the like.

Alternatively, if the merchant 10 or another institution, other than the issuing financial institution 40, provides the digital wallet to the user 2, the issuing financial institution 40 may not receive all the transaction information from the traditional transaction processing channels or from the digital wallet. As such, the issuing financial institution 40 may have to receive additional transaction information from another application associated with the user 2 and compare the transaction information received through the traditional channels in order to associate the additional information with the transaction. In other embodiments, the issuing financial institutions 40 may have partnerships with the merchants 10 or other institutions to receive additional transaction information from the digital wallets provided by the merchants or other institutions when the users 2 enter into transactions using the digital wallets.

Moreover, when there is communication between the digital wallets of the users 2 and the issuing financial institution 40 or another institution, transactions in which the user 2 may enter may be pre-authorized (e.g., pre-qualified) to determine what accounts (e.g., tokens) may be used to complete the transaction, without having to arbitrarily choose an account for the transaction. In the case when there are multiple digital wallets or multiple accounts, the account that is pre-authorized or the account that provides the best rewards may be automatically chosen to complete the transactions. Additional embodiments of the invention will now be described in further detail in order to provide additional concepts and examples related to how tokens may be utilized in these illustrated token system processes 1 or in other token system processes not specifically described in FIGS. 1 through 3.

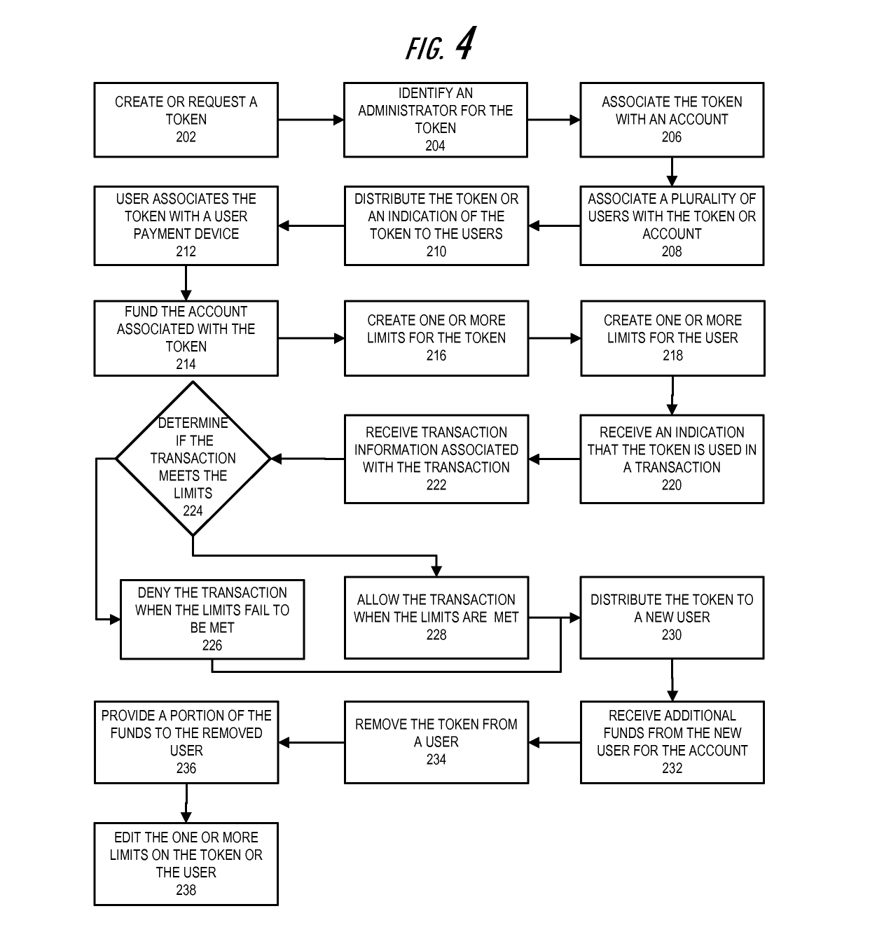

FIG. 4 illustrates a token collaboration process flow 200, in accordance with one embodiment of the invention. As illustrated by block 202 of FIG. 4, a shared token is created or requested for the collaboration of the users 2. An institution (e.g., issuing financial institution, third party institution, or the like) may create the token for a business client or retail client. In one embodiment, the business client or retail client may request the token from the institution. For example, in one embodiment the business client may request a token for a collaborative group of employee users 2 for use with one or more customers of the business client during one or more business trips, for one or more projects, for one or more transactions, or the like. With respect to the retail client, the retail client may request a token for a collaborative group of retail users 2 (e.g., group of family members, group of friends on a trip, or the like) for one or more trips, for use on one or more projects, for one or more transactions, or the like. In other embodiments of the invention, the business client or retail client may create the token and notify the institution storing the account information of the token created. As such, the institution may store the relationship between the token and the account information to allow use of the token in transactions.

Block 204 of FIG. 4 illustrates that the requesting business client or retail client may appoint an administrator to oversee the use of the shared token. For example, in the case of a business client, the business client may associate one or more administrators (e.g., employees) with the token to set and control the spending of a collaborative group employee users 2 that are granted access to use the token. In the case of a retail client, the retail client may associate one or more administrators (e.g., parents, trustee, legal guardian, or user 2 that creates or is a part of a group of users 2, or the like) with the token to set and control the spending of the collaborative group of retail users 2 (e.g., kids, grandparents, any other dependents, group of users 2, or the like) that are granted access to use the token. The administrators may be responsible for creating, adding, or removing users 2 from the collaborative group of users 2, setting limits on the transactions in which the users 2 may enter, or the like. In some embodiments there may be more than one administrator for a shared token used by a collaborative group of users 2. Moreover, the administrators may also be users 2 within the collaborative group of users 2.

FIG. 4 further illustrates in block 206 that the shared token is associated with an account. As previously discussed, a shared token may be associated with an account by the issuing financial institution 40 or a third party (e.g., tokenization service 50) independent of the issuing financial institution 40, for a business client or a retail client. For example, in the case of a business client, the token may be associated with a business account (e.g., a corporate card) that a collaborative group of employee users 2 may utilize in order to enter into transactions related to the business. In other embodiments of the invention, in the case of a retail client, the token may be associated with an account of the administrator (e.g., parents may associate the tokens with one or more accounts owned by the parents) and/or an account of another user 2 within the collaborative group of users 2. In some embodiments, the token may be associated with multiple accounts that may be debited or charged equally, or charged based on assigned limits, when a transaction is entered into by one or more of the collaborative group of users 2. However, in some embodiments of the invention the account associated with a token may be a new account that is created just for the collaborative group of users 2 and is funded by the collaborative group of users 6, as is discussed in further detail below.

As illustrated by block 208 one or more users are associated with the shared token, or the account associated with the shared token. For example, the user 2 (e.g., employee users, retail users, or the like) may be authorized as users 2 of the token (e.g., by the administrator) or otherwise associated with the account with which the shared token is associated. For example, in some embodiments user information may be associated with the shared token or the account, such as a user name, user identification number, payment device 4 identifier, digital wallet identifier, or the like. In other embodiments the administrators (e.g., of the business client or retail client) may determine what users 2 may download, access, or otherwise utilize the shared token to enter into transactions, by adding the user information to a list that allows the users 2 to gain access to the shared token. In other embodiments of the invention, the business client or retail client may utilize a messaging system (e.g., e-mail, text message, online banking account message, social media message, or other like message over another communication channel) to send a notification message to the one or more users 2 indicating that the users 2 may join a collaborated group of users 2. In still other embodiments, the users 2 may send a request to join a collaborative group of users 2 to the issuing financial institution 40. As such, in some embodiments the users 2 may be manually or automatically added to the collaborative group of users 2 before being asked to join a collaborative group of users 2, or provided with the shared token or access to the shared token. In other embodiments the users 2 may be added only after the users 2 are sent a message to join a collaborative group of users 2, and acceptance of the invitation join is received from the user 2.

As illustrated by block 210, the shared tokens or access to the shared tokens may be distributed to the plurality of users 2. In some embodiments of the invention, the business client or retail client may again utilize a messaging system to send a notification message to the one or more users 2 illustrating how to join a collaborated group of users 2, and be allowed to the use the shared token for transactions. As previously discussed, the collaborative group of users 2 may be formed to jointly utilize a shared token for transactions related to one or more customers, one or more specific transactions, one or more projects, one or more trips (e.g., business trips, vacations, or the like). The message or another like communication may securely provide the shared token to the users 2, or in the alternative may provide the users 2 the necessary token information to access the shared tokens when entering into transactions. As such, the users 2 may download, access, or otherwise identify the shared token. The actual shared tokens or the shared token information used to access the tokens may be stored within the users' payment devices 4, or stored in an application that may be accessed by the users' payment devices 4.

Block 212 of FIG. 4 illustrates that the shared token, or otherwise the shared token information that identifies where to access the shared token to enter into a transaction, may be stored in the payment device 4. For example, in some embodiments the payment device 4 or a digital wallet within the payment device 4 may store the token information (e.g., store the actual token numbers, store a link to the token numbers, or otherwise communicate with a system that stores the token information, such as a cloud system) instead of the actual account number or other account information with which the token is associated. In other embodiments, the shared token or shared token information may be stored in an application that can be used for in-person transactions at a POS or for e-commerce transactions. In still other embodiments of the invention, the shared token or shared token information may be stored on multiple payment devices (e.g., personal mobile device, business mobile device, electronic credit card, or any other like device discussed or not discussed herein) of a single user 2. As such, the user 2 may enter into transactions using the same shared token over various payment devices 4.

Block 214 illustrates that the account associated with the shared token is funded. In some embodiments of the invention, the account may be a credit account, a debit account, or another like account. Furthermore, the shared token may be associated with an account that is already funded, such as a corporate account or family account that already has associated funds. As such, additional funds may be made available or added to the account, if needed. In other embodiments, the account may be a new account, and as such the account may need to be funded in order to enter into transactions using the shared token. As such, in one embodiment the account may be a credit account, and funding the account indicates placing a spending account limit on the account. The amount of funds available in the account may be based on the credit worthiness of the users 2 associated with the account, or the client (e.g., business client), for which the account is being used. The amount of funds available may also be based on collateral associated with the account by the users 2. Each user may be responsible for a portion of the maximum spending limit of the account, or in other embodiments may be responsible for the entire spending limit jointly and severably. In other embodiments of the invention the account may be a debit account, and funding the account indicates debiting funds from the one or more users 2 (or other funding sources) into the account. Each user associated with the account may provide the same amount to the account (e.g., $500 each), or each user may provide different amounts. The amount of funds contributed to the account (e.g., debit account), or attributed to the account (e.g., credit account), by each user 2 may be tracked in order to determine how much the users 2 may spend, or how much should be returned to the users 2 after they leave the collaborative group of users 2. In some embodiments one or more users 2 may contribute funds on a recurring basis. In still other embodiments, if one or more users 2 enter into transactions without using the shared token (e.g., use other user accounts) the one or more users 2 may be reimbursed using funds from the account associated with the shared token.

Block 216 of FIG. 4 illustrates that one or limits are placed on the shared token. As such, the limits may be applied to any shared token regardless of how many users 4 or payment devices 4 are associated with the shared token (e.g., tokens associated with different users 2 or tokens associated with multiple payment devices 4 associated with the same users 2). Alternatively, or in addition to the shared token limits, block 218 illustrates that one or more limits are placed on the users 2 (e.g., individual users, groups of users, or the like) within the collaborative group of users 2. As such, the limits may be applied to the users 2 regardless of the one or more shared tokens associated with the users 2 or the payment devices 4 used by the users 4. In other embodiments of the invention the limits may be placed on the payment devices 4 or digital wallets within the payment devices 4. Examples of the limits may include the maximum aggregate amount spent using the account, the maximum single transaction amount, geographic limits (e.g., specific merchant, area, zip code, city, county, state, country, radius from a specified point, route along one or more roads, or other like geographic location), merchant limits, product limits, or the like. Additional limits may include time period limits, such as hourly, time of day, daily, weekly, monthly, or custom timeframes (e.g., every other day, every Saturday, or the like). All the different types of limits may be approval limits or denial limits, such that for example the limits may include authorizing transactions in a specific geographic area and/or for a particular time, or denying transactions in a specific geographic area and/or for a particular time. In other embodiments of the invention the client, or administrators associated with the client, may have the ability to lock, unlock, suspend, or the like the use of the shared token or digital wallet. When the limits are placed on the shared token, if the token becomes misappropriated and replaced with another shared token, the limits maybe lost or have to be transferred to the new replacement shared token. As such, in some embodiments when a token is replaced the limits are transferred to the new token, while in other embodiments the limits may have to be reinstituted. In other embodiments, the limits may be associated with the individual users 2, groups of users 2, or the like, which allows the different limits to be placed on the users 2 globally, on multiple users 2, or on individual users 2, as desired by the client. Moreover, in one embodiment a user 2 may have a first shared token associated with a first collaborative group of users 2, and a second shared token associated with a second collaborative group of users 2. In some embodiments, limits may be placed globally on the use of both tokens, on the tokens themselves, groups of users 2 within the tokens, or on the individual users 2. It should be understood that any combination of limits described herein may be used to set various limits.

Block 220 of FIG. 4 illustrates that an institution receives an indication that a shared token is being used in a transaction. Also, as illustrated in block 222, the institution also receives transaction information associated with the transaction. The institution that receives the indication of the transaction, and/or the transaction information, was previously described with respect to FIGS. 1-3. As such, the institution may be the issuing financial institution 40, the tokenization service 50 institution, and/or the client that sets the limits. In the embodiment in which the client sets and/or stores the limits, the issuing financial institution 40 or the tokenization service 50 institution (e.g., through the digital wallet or another application) may communicate with the client to determine, or otherwise access, the limits stored at the client, and determine if the transaction should be allowed or denied before authorizing or denying the transaction. In other embodiments, the merchant 10 (e.g., through the digital wallet or another application) may communicate with the client to determine, or otherwise access, the limits stored at the client before passing the transaction on for processing or before authorizing or denying the transaction.

As such, as previously discussed with respect to FIGS. 1 through 3, or furthermore with respect to blocks 220 and 222 in FIG. 4, a determination is made as to if the transaction associated with the shared token being used meets the limits, as illustrated by block 224. In one embodiment the highest levels of limits (e.g., global limits) may be asserted first, then the next levels of limits (e.g., group limits, sub-group limits) may be asserted next, then the individual level of limits (e.g., individual user, token, accounts in the digital wallets, or the like limits) may be asserted in order to determine if the transaction should be allowed or denied. In other embodiments of the invention, the inverse may occur, and as such, the individual limits (e.g., user limits, token limits, or the like) may be asserted first, then the sub-group or group limits, and finally the global limits. In other embodiments of the invention, the limits may be asserted in any order.

As illustrated by block 226, if the transaction (e.g., transaction information) fails to meet the limits (e.g., violates the limits) the transaction may be denied. Alternatively, if the transaction (e.g., transaction information) meets the limits (e.g., passes the limits) the transaction may be allowed.

In some embodiments, a new user 2 may be periodically added to the collaborative group of users 2 as illustrated by block 230 in FIG. 4. As such, in some embodiments, new users 2 are added as was described with respect to blocks 208 to 212 above. As illustrated by block 232 the account associated with the shared token may receive additional funding from the new user 2 as was previously discussed with respect to block 214.

Block 234 illustrates that the shared token may be disassociated from the user 2 (e.g., user payment device 4, user digital wallet, or the like) in order to remove the user 2 from the collaborated group of users 2. The administrator of the client (e.g., business client, retail client, or the like) may prevent one or more users 2 in the group of users 2 from utilizing the shared token. For example, the administrator may remove the shared token or link to the shared token from the payment or digital wallet of the user 2. In another embodiment, the administrator may block of the use of the token by the specific user 2. The administrator may also replace the token for all of the other users 2 in the collaboration group except for the user 2 that is to be removed from the collaboration group. In still other embodiments, the token may remain with the user 2, however, when user information is captured during the transaction and sent for authorization the transaction may be denied by the institution storing the request to prevent the user 2 from continuing to use the shared token. In other examples, instead of the shared token being disassociated from the user 2 the token information that links the payment device (e.g., digital wallet) to the shared token may be disassociated from the user 2 (e.g., the payment device 4).

Block 236 illustrates that when the shared token or link to the shared token is dissociated from the user 2, or the user 2 is otherwise prevented from using the shared token a portion of the user's remaining funds contributed to the account may be returned to the user 2. As discussed, the purchases made by each user 2 may be tracked, and in one embodiment the disassociated user 2 is refunded a portion of his contribution, based in part on the disassociated user's contribution, the purchases made by the dissociated user 2, distributions taken by the dissociated user 2 in the past, the purchases made by other user's associated with the shared token, the limits related to use of the funds by the users 2, or the like.

As illustrated by block 238, in some embodiments of the invention the limits on the tokens, users 2, payments devices 4, accounts, or the like may be edited as the business clients, retail clients, or the like (e.g., administers of the client) have changing needs related to controlling the transactions of the users.

In one embodiment, the tokens, accounts, users 2, limits, or the like may be created and assigned as described herein through the use of graphical interfaces that allows the administrator (e.g., or other person) within the business client, retail client, or the like to manage the use of the shared token as desired.

Embodiments related to FIG. 4 have been described herein as being related to a shared token that may be utilized by a collaborative group of users 2. In other embodiments of the invention there may be more than one shared token associated with a user 2, payment device 4 of the user 2, a digital wallet associated with the payment device 4, or the like.

In still other embodiments of the invention, instead of using a single shared token for the collaborative group of users 2, multiple shared tokens may be provided to the collaborative group of uses 2. The multiple shared tokens may be associated with a single account or multiple accounts for the collaborative group of users 2. As such, when entering into a transaction the user 2 may select the token, account, or the like that the user 2 would like to utilize in the transaction. Moreover, if the token associated with a single user becomes misappropriated then only the single token for the specific user 2 is replaced instead of having to replace the shared token with all of the users 2.

As such, in some embodiments of the invention instead of providing a shared token for use by a collaborative group of users 2, each individual user 2 is associated with one or more individual tokens (e.g., unique tokens) associated with the collaborative account. Moreover, if the user 2 has multiple payment devices 4, the individual tokens for a single user 2 may be different for each separate payment device 4. For example, in the case of a business client, a plurality of tokens may be associated with a business account (e.g., a corporate card account) that the employee users 2 may utilize in order to enter into transactions related to the business. As an example, a first token associated with a first business account may also be associated with a first employee user 2. A second token associated with the first business account may be associated with a second employee user 2. In addition, a third token associated with a second business account may also be associated with a first employee user 2. As such, the first employee user 2 may be associated with multiple tokens, which may each be associated with individual business accounts (e.g., business account 1 and business account 2, or the like). Additionally, a first employee user 2 and a second employee user 2 may be associated with the same business account through the use of different tokens.

In other embodiments of the invention, in the case of a retail client, a plurality of tokens may be associated with an account of the administrator (e.g., parents may associate the tokens with one or more savings, checking, or other like accounts owned by the parents). As discussed with respect to an employee user 2, a retail user 2 may also be associated with one or more tokens that are each associated with one or more separate accounts. For example, a first retail user 2 may be associated with a first token and a second token, wherein the first token is associated with a first retail account (e.g., a debit account) and a second token is associated with a second retail account (e.g., a credit account). Additionally, a second retail user 2 may be associated with the first retail account and the second retail account using a third token and a fourth token, respectively.

In other embodiments of the invention the individual users 2, and thus, the individual tokens associated with the users 2 may be categorized into various accounts, groups, sub-groups, or the like. As such, the individual tokens and individual users 2 may not only be associated on an individual level, but may also be associated with other users 2 and groups. For example, the client or administrator may associate individual users 2 with various accounts (e.g., user 1 and user 2 may both be associated with account 1, while user 1 is also associated with account 2). The individual users 2 within an account or across accounts may also be categorized into groups of users 2, such as a first set of users 2 being associated with a first group (e.g., sales group), and a second set of users 2 being associated with a second group (e.g., procurement group, engineering group, account group, or the like). Moreover, individual users 2 within a group may be associated with sub-groups, such as the users in the first group may be further defined into a first sub-group (e.g., sales team 1) and a second sub-group (e.g., sales team 2). The sub-groups may further be divided into additional sub-groups until the individual user level is reached. As such, the users 2 may be structured into hierarchal levels within a business client, in order to place limits on the use of one or more of the business accounts based on the hierarchal levels.

In addition to the users 2, or in the alternative, the tokens that are associated with the individual users may be categorized into the hierarchal levels described above (e.g., account level, group level, sub-group level, additional sub-groups, an individual level, or the like). In one embodiment the individual tokens are categorized together after they are assigned to the users 2 and as the users 2 are categorized into the various levels. Alternatively, the tokens may be categorized together before the users 2 are categorized, and thus assigned to the users 2, in part, based on the categories to which the tokens are assigned. For example, a set of tokens may be assigned to a specific account and this set of tokens may be further categorized into a first token group and a second token group. As is the case with the users 2, the first token group may be further divided into a first sub-group, a second sub-group, or the like. Each of the tokens within a sub-group may be further divided into additional sub-groups. As such, the tokens may be categorized and assigned to different accounts, group, sub-groups or the like, and on the individual user level.

By categorizing the tokens and/or the users 2 into the various levels, this may allow the client (e.g., the administrator) to place limits on a global level, account level, group level, sub-group level, or the like, as well as the individual level. For example, a business client can control the transactions of employee users 2 globally, within teams or groups of employees, and/or on individual employees. In another example, this may allow a retail client to set limits on groups of retail users 2 (e.g., kids, trust beneficiaries, grandparents, legal dependents, or the like).

As discussed throughout this application the individual tokens may also be associated with digital wallets, as such the tokens, users 2, and accounts may further be grouped based on the one or more digital wallets with which each is associated.

As such, as was the case with the shared token, one or more limits may be placed on the individual tokens, users 2, accounts, digital wallets, or the like as discussed throughout this application. In some embodiments of the invention, the limits may be placed on the tokens, the users 2 (e.g., the individual users, the sub-group of users, the group of users, or the users associated with an account, or the like based on the tokens or the users), the digital wallets of the users 2, or the actual accounts listed within the digital wallets. For example, when the limits are placed on the token, if the token becomes compromised and replaced with another token, the limits maybe lost or have to be transferred to the new replacement token. As such, in some embodiments when a token is replaced the limits are transferred to the new token, while in other embodiments the limits may have to be reinstated. In other embodiments, the limits may be associated with the individual users, groups of users, sub-groups of users, or the like. This allows the different limits to be placed on the users globally, on multiple users, or on individual users 2 as necessary. As such, in these embodiments when a token is compromised and requires replacement, the limits may not be affected because the limits are not specifically tied to the tokens.

In addition, the limits may be further placed on the digital wallet or individual accounts within the digital wallet. For example, users 2 may utilize a first account and a second account associated with a digital wallet. The users 2 may be within the same sub-groups and groups, but the first account and the second account may have different limits or the same limits. Alternatively, the first account and second account may be associated with different sub-groups and groups, and either have different limits or the same limits. It should be understood that any combination of limits described herein may be used to set various limits on different levels described within this specification, or on levels not specifically described within this specification.

The transactions that utilize an individual token may be processed in the same way as described with respect to the processes illustrated in FIGS. 1-3 and described in further detail above. As such, when a transaction request is received a determination is made as to if the transaction associated with the individual token being used meets the limits. In one embodiment the highest levels of limits (e.g., global limits) may be asserted first, then the next levels of limits (e.g., account limits, group limits, sub-group limits, or the like) may be asserted next, then the individual user level of limits (e.g., individual user limits, token limits, specific digital wallet limits, or the like) may be asserted in order to determine if the transaction should be allowed or denied. In other embodiments of the invention, the inverse may occur. and as such the individual limits may be asserted first, then the sub-group or group limits, the account limits, and finally the global limits. In other embodiments of the invention, the limits may be asserted in any order.

If the transaction (e.g., transaction information) fails to meet the limits, the transaction may be denied. Alternatively, if the transaction (e.g., transaction information) meets the limits then transaction may be allowed.

While the system has been described as determining whether the transaction meets the limits and either allowing or denying a transaction based on that determination, in some embodiments the limits (also described herein as filters), may also be responsive to transaction information. For example, exceptions to the filters may allow a transaction even if the filter is not met. In an embodiment, the system evaluates the transaction information to determine: (1) does the transaction meet the limits; and (2) if the transaction does not meet the limits, does the transaction qualify for an exception to the limits. If the system determines that a positive response to either query, then transaction may be allowed.

In some embodiments, the exceptions are based at least in part upon the transaction information. For example, the system may determine that a transaction does not meet a category limit because doing so would cause the token to exceed the category limit for the time period. In this example, however, the system also determines that the token is near, e.g., within one week, within three days, within one day, or the like, the expiration date of the token or the current evaluation period for the token and that the token has remaining funds in a different category. Given the short period of time remaining for the expenses to be made, the system may determine that the transaction falls within an exception and allow the transaction. In another example, the system may determine that the user is outside of geographic limits defined by a route. The system, however, determines that the user has conducted a transaction at the merchant frequently in the past and therefore allows the transaction based on the previous number of transactions at the merchant. These examples use multiple types of transaction information, e.g., the date of the transaction, the location of the transaction, the category of the transaction, the amount of the transaction, and the like, to determine if the exceptions apply. In some embodiments, only a single piece of transaction information applies. For example, the system may always permit transactions that are associated with a specific category, for example, emergency expenses. The system may always permit transactions at emergency rooms, doctors' offices, and the like.

In some embodiments, the exceptions are determined by the system and/or the user. For example, the system may provide a list of exceptions based on the user's transaction history. If the user has a favorite coffee shop, the system may allow transactions at the coffee shop up to a certain amount even if the transaction would not meet a limit. The user or an administrator may provide exceptions based on location or other transaction information. For example, the user may input exceptions that allow transactions within a specific region, e.g., a city, which would not be allowed outside of the specific region. The exceptions may be changed at any time by the system or user.

The exceptions may be limited by frequency, amount, percentage of the limit, or the like. For example, a transaction may qualify for an exception but only up to a certain percentage of the funds remaining in a related category. For example, a transaction may qualify for an exception because the expense period for the token is almost expired and there are remaining funds in a first category. The system may permit a transaction in a second category up to some percentage (e.g., 50%) of the funds remaining in the first category.

The transaction-responsive limits are designed to provide flexibility to the system and better serve the user. The transaction-responsive limits may be tailored to the user or generic to the token and/or system. By providing for transaction-responsive limits, the system allows transactions that would otherwise be denied based on binary yes/no limits when the transaction information indicates the appropriateness of the transaction.

As stated and described above, limitations may be applied to the use of an account associated with a token to help regulate or control user transactions. Utilizing limitations on the use of the account associated with the token provides flexibility on applying limits and may further increase security surrounding the unauthorized use of a user account and transmittal of transaction information, account information, monetary funds, or other potentially sensitive information.

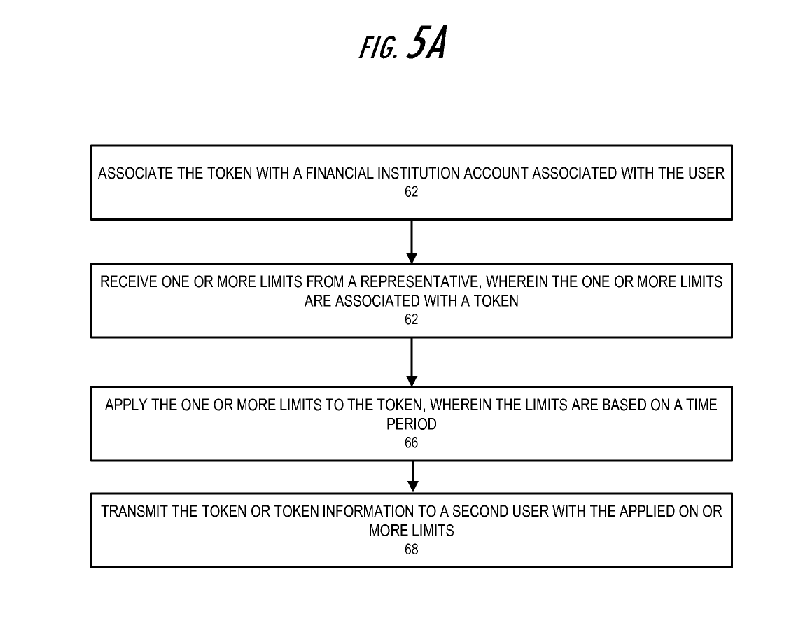

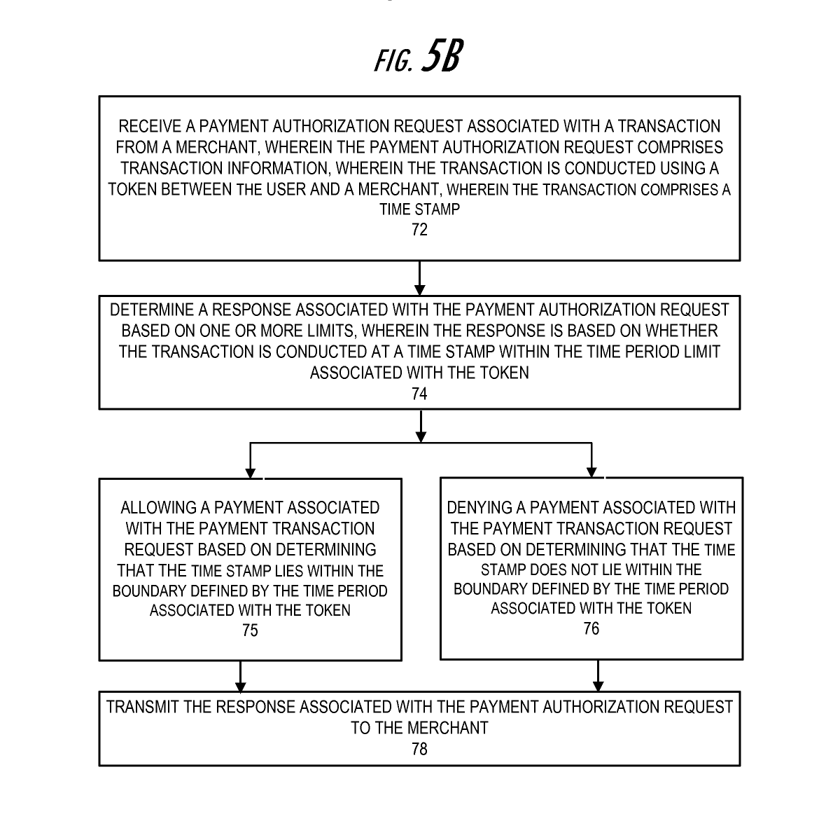

FIG. 5A illustrates a process flow for applying one or more limits to a token (e.g., permanent token or temporary token). As previously discussed throughout this specification the system may be configured to associate one or more tokes with one or more accounts of a user (e.g., a business client account or a retail client account at a financial institution) as shown in block 62. In addition, as previously described the one or more tokens may be associated with a payment device 4, digital wallet, or the like of a user 2 that is authorized to utilize the one or more accounts. As previously discussed, in one aspect, associating the one or more tokens with one or more financial institution accounts associated with the client may allow a user 2 that has authorization to utilize the token, to select of one or more financial institution accounts in order to enter into a transaction (e.g., using a single token, or multiple tokens). As such, the present invention may be configured to initiate the presentation of a user interface to enable an administrator to select at least one financial institution account with which to associate the one or more tokens.

In some embodiments, the system may be configured to receive one or more limits from an administrator, a user associated with a client (e.g., business client, retail client, or the like), or other like entity associated with the account, wherein the one or more limits are associated with a token (or the individual user), as shown in block 64.

In response to receiving the one or more limits, the system may be configured to apply the one or more limits to the token, as shown in block 66. In one aspect, applying one or more limits to the token includes instituting restrictions on the token to narrow the use of the token within the applied one or more limits. In one aspect, applying the one or more limits comprises applying one or more limits to the token for a predefined time period. In some embodiments, the predefined time period may be defined by a first time stamp and a second time stamp. For example, the predefined time period may be at least one of a number of minutes, hour(s), day(s), week(s), month(s), or the like. In one aspect, the predefined time period may be a consecutive time period (e.g., consecutive days). In another aspect, the predefined time period may not include consecutive time periods. For example, the predefined time period may be a nonconsecutive time periods (e.g., every other Monday, every other week, or the like). In another example, the predefined time period may be any two days in a week. For example, a supervisor in an office environment (e.g., an administrator) may be charged with the responsibility of maintaining an expense account associated with every day office expenses. In such situations, the supervisor may provide each employee user 2 with a token. To restrict the use of the token (e.g., associated with the expense account), the supervisor may apply a time restriction, say, between 9:00 a.m. and 5:00 p.m. to each token. In some embodiments, the system may be configured to enable the administrator to modify the limits applied to the token before or at a time the transaction is conducted. Continuing with the previous example, an employee user 2 of the supervisor may have a client meeting outside of the time period (e.g., for a dinner at 6 pm). In such situations, the supervisor may extend the time period from the previous 5:00 p.m. to 10:00 p.m. to enable the employee to use the token and accommodate the client meeting for a specific day.

Instead of changing the previous limits associated with the token, in one embodiment the users 2 may be temporarily given access to a temporary token for a specific time period (e.g., token that is already stored on the payment device 4, a new token provided, or the like). As such, an institution may push (or a user 2 is allowed to pull) new tokens for use by the user 2 whenever the administrator wishes to change or add new temporary limits. For example, if the limits are to be modified for a period of time (e.g., authorizing transactions after 6 pm), the administrator may issue a new token that allows transactions to occur after 6 pm for a specific day. In some embodiments, when the temporary token expires and is no longer valid (e.g., it turns midnight of the next day) the limits (e.g., the allowed or denied transactions) on the account are removed. Therefore, in the present invention, limits may not be required to be constantly updated, but rather new temporary tokens may be activated for use by the users 2.

In additional embodiments, other limits may also be placed on the temporary tokens. For example, in addition to the time period limits, the tokens may be limited to a predetermined number of merchants 10 (e.g., a finite number of allowable/deniable merchants 10), a particular group of merchants 10 or one or more merchant categories, (e.g., only grocers), a product type, a group of products or product categories (e.g., only food or gasoline purchases), an amount limit associated with the transaction (e.g., no transaction amounts above a predetermined threshold are allowed, or a minimum transaction amount), a history of purchases, user behavior, a frequency of purchases, a geographic location (e.g., no transactions allowed outside of a predetermined range, specific merchant, area, zip code, city, county, state, country, radius from a specified point, route along one or more roads), or the like.

For example, continuing with the previous example, if the user 2 is on a business trip and needs to take a customer on an unexpected dinner, the employer (e.g., administrator) may issue the user a new token that can be used not only for the specific time period, but also for a specific restaurant (e.g., merchant) in order to limit the transaction to allow a transaction that might not have been previously allowed.

In these examples, the temporary token is provided to the user 2 and it may disappear after the time period is extinguished and/or the transaction is completed. Therefore, the user 2 or multiple users 2 may have real-time access to a larger pool of funds (e.g., a business count) based on access to a temporary token that includes limits associated with the token. If the limits were based on the user 2 the administrator or other entity may have to first modify the limits associated with the user 2 to allow the transaction and thereafter change the limits associated with the user 2 again after the transaction occurs. Thus, the temporary token may serve as a temporary access point to an account.

In another example, in a collective group of users 2 instead of authorizing all of the users 2 within the collaborative group of users 2 the same access to the account, the administrator or other entity may provide each user 2 multiple tokens (e.g., single use or multi-use tokens) that may be used for specific types of transactions with specific limits. If the limits need to change for the one or more users 2, some of the tokens may be removed and additional tokens may be provided to the users 2 with new limits as opposed to manually configuring the limits associated with each of the users 2. For example, one user in the collaborative group may receive five (5) $20 tokens that can be used specifically at various merchants 10. As the funds are used for each of the tokens the tokens may disappear. Alternatively, another user in the collaborative group of users 10 may receive $100 tokens that can be used to enter into transactions for the hotel rooms of the collaborative group of users 10.

In response to applying the one or more limits to the tokens, the system may be configured to transmit the token (or otherwise activate a stored token) to the user 2 with the applied one or more limits, as shown in block 68. This may comprise automatically uploading the token (or token information to access the token during a transaction) to the user's payment device 4 or authorizing the users 2 to download the token to the payment device 4. In one aspect, the system may transmit the token to the user 2 via a connection over the Internet or another communication medium using an application, an e-mail, text message, online banking account message, social media message, or other like message over another communication channel. As discussed the token may be associated directly with the payment device 4, with a digital wallet on the payment device, or through another application.

FIG. 5B illustrates a process flow for authorizing payment for a transaction conducted using a token for a specified user. In some embodiments, the system of the present invention (e.g., issuing financial institution system, or the like) may be configured to receive a payment authorization request associated with a transaction from a merchant 10, as shown in block 72. In some embodiments, the payment authorization request includes transaction information. In one aspect, the payment authorization request may include transaction information, which may include a time stamp of the transaction. In other embodiments of the invention the transaction information may be received in another way, such as from the payment device 4 of the user 2 or an application associated with the payment device 4. For example, a location-determining device may be used to identify a time stamp when a user 2 is located at a particular merchant with whom the user 2 entered into a transaction. Additional transaction information may include at least one of a merchant location, a transaction amount, a product/service associated with the transaction, a time stamp of the transaction, token information, or the like.

In response to receiving the payment authorization request, the system may be configured to determine a response associated with the payment authorization request based on the one or more limits. In one embodiment, the response is based on whether the time stamp associated with the transaction lies within the time period limit associated with the token, as shown in block 74. In one aspect, the response includes permission authorizing the payment associated with the transaction request based on determining that the time stamp associated with the transaction is within the time period limit applied to the token, as shown in block 75. In another aspect, the response includes permission denying the payment authorization request based on determining that the time stamp associated with the transaction does not lie within the time period limit applied to the token, as shown in block 76.

In some embodiments, the payment authorization request is transmitted to payment processing institutions (e.g., the tokenization service 50, the acquiring financial institution 20, the payment association networks 30, the issuing financial institution, or the like) by a transaction processing device at a POS terminal associated with the merchant 10. In one aspect, the transaction processing device associated with the merchant may be in the same location as the merchant 10. In another aspect, the transaction processing device associated with the merchant 10 may be in a different location relative to the location of the merchant 10. For example, instead of a POS terminal, the transaction processing device may be at least one e-commerce payment system capable of conducting a transaction via the Internet.

After determining the response associated with the payment authorization request, the system may be configured to transmit the response associated with the payment authorization request to the merchant 10, as shown in block 78.

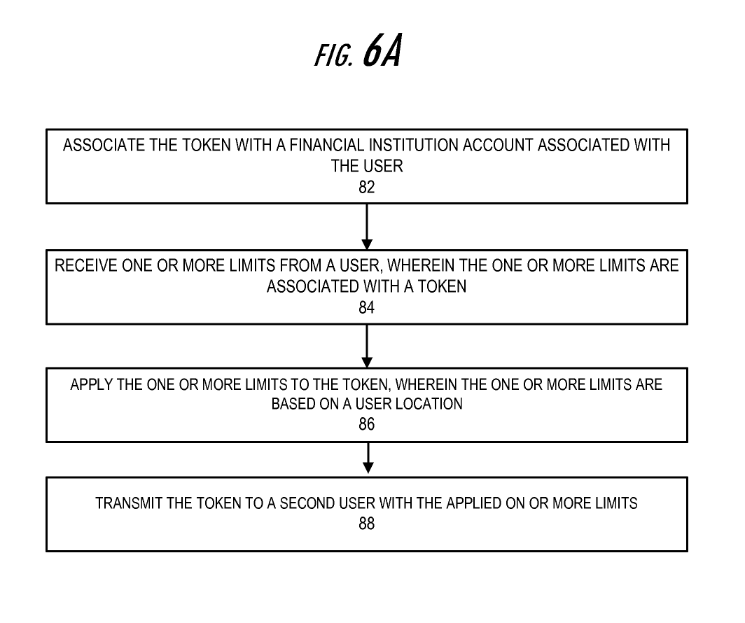

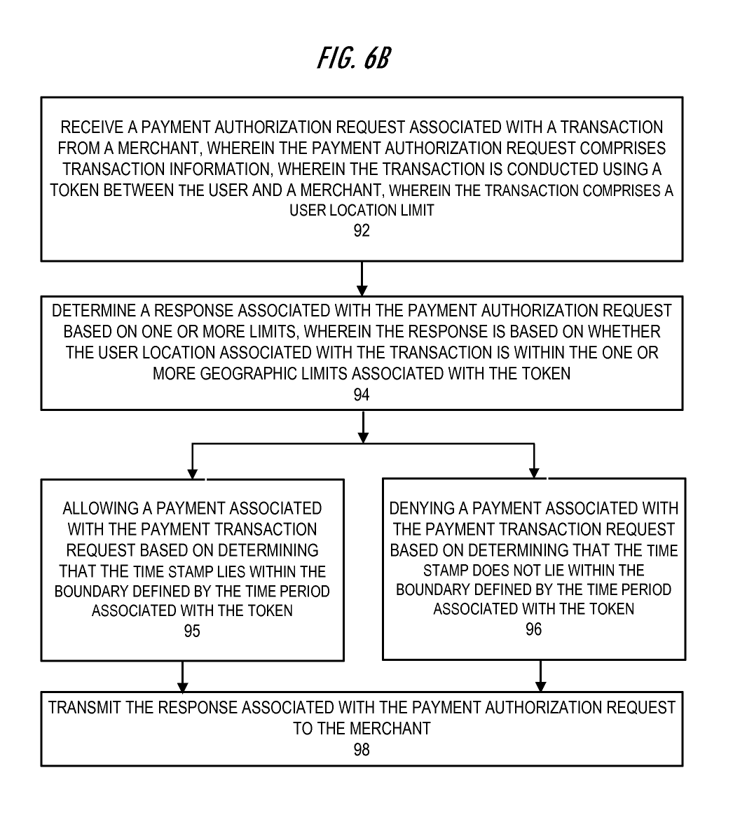

FIG. 6A illustrates a process flow for applying geographic limits on a token (e.g., permanent token or temporary token). As previously discussed throughout this specification, the system may be configured to associate one or more tokens with one or more accounts associated with the user (e.g., a business client account or a retail client account at a financial institution), as shown in block 82. In addition, as previously described the one or more tokens may be associated with a payment device 4, digital wallet, or the like of a user 2 that is authorized to utilize the one or more accounts. As previously discussed, in one aspect, associating the one or more tokens with one or more financial institution accounts associated with the client may allow a user 2 that has authorization to utilize the token to select of one or more financial institution accounts in order to enter into a transaction (e.g., using a single token, or multiple tokens). As such, the present invention may be configured to initiate the presentation of a user interface to enable an administrator to select at least one financial institution account with which to associate the one or more tokens. In some embodiments, the system may be configured to receive one or more limits from an administrator, a user associated with a client (e.g., business client, retail client, or the like), or other like entity associated with the account, wherein the one or more limits are associated with a token (or the individual user), as shown in block 84.

In response to receiving the one or more limits, the system may be configured to apply the one or more limits to the token, as shown in block 86. In one aspect, applying the one or more limits further comprises applying one or more limits to the token based on at least a user location. In one aspect, the user location may be determined based on a location-determining device as described herein, such as a GPS device, an IP address, a WiFi signal triangulation, a merchant address in the transaction information, or other like location determination.

In some embodiments, the one or more limits may be a geographic boundary defined by a geographic radius. In other embodiments the geographic limits may be no transactions allowed outside of a predetermined range, specific merchant, area, zip code, city, county, state, country, or the like. For example, an administrator of a business account my want to prevent user 2 of a corporate account from making transactions outside of the geographic locations in which the customer's of the business are located. For example, the administrator may limit the use of the corporate card to the cites in which the customers are located by adding a radius limit such that only transaction made by users 2 within 10-miles (or any other like distance) from the city would be allowed. As such, when a user 2 enters into a transaction using the token associated with the corporate account, the transactions will be denied if they are outside of the 10-mile radius of the city.

In other embodiments, the one or more limits may be applied to the token based on a transportation route defined by the administrator. For example, an administrator, such as a parent, may define a transportation route from a source to a destination, such as trip for a child from college home based on for example an online mapping interface. A limit of 5 miles away from the route for allowed transactions may be place on the token in order to prevent the child from taking an alternate route. As such an administrator my limit the transactions of user 2 to specific routes.

In other embodiments, the one or more limits may be one or more geographic locations. For example, the administrator may define one or more geographic boundaries defined by zip codes, electrically bounded areas (e.g., Wi-Fi spots within a mall), states, area codes, or other like geographic boundaries in which transactions may be allowed or denied.

In other embodiments of the invention other types of limits other than the geographic limits may be applied to the token along with the geographic limits, or in place of, the geographic limits, as discussed throughout this specification. As such, specific merchants, merchant types, products, product types, transaction amounts, or other limits described or not specifically described herein may be associated with the token in order to limits the transactions that may be made using the token.

In some embodiments, the one or more limits may be limiting the token to a geographic area based on a user location and a time period. For example, the apparatus may be configured to apply a limit restricting the use of a token to a geographic radius around a user's residence between 5:00 p.m. and 10:00 p.m. In one aspect, the apparatus may be configured to limit the use of a token within a first geographic radius during a first time period and a second geographic radius within a second time period. In another example, the apparatus may be configured to apply a limit restricting the use of a token to a geographic radius around a user's office location between 9:00 a.m. and 5:00 p.m., a restriction based on a user's residence between 5:00 p.m. and 6:00 p.m., and a wider radius around the user's residence between 6:00 p.m. and 10:00 p.m.

In some embodiments, the one or more limits may be based on an IP (internet protocol) address associated with the IP gateway. Typically, an IP gateway is a node that allows communication between networks. An IP gateway, sometimes referred to as a router of internet access device (IAD), can be as simple as a computer that controls the dataflow between two networks. The one or more limits may be based on restricting data flow between the user's IP address and one or more specific IP addresses of one or more IP gateways associated with one or more merchants. In one aspect, the limits may include limits on making transactions with particular websites, for example through the URL addresses of the websites, merchants that sell products through the URL addresses, or the like. For example, the apparatus may be configured to limit the use of a token to conduct an e-commerce transaction with a merchant based on an IP address of the IP gateway associated with the merchant's network. In one aspect, an e-commerce transaction may include a transmission of transaction information from the user's web browser to a merchant's IP webserver through the merchant's IP gateway. In response, the apparatus may be configured to detect the IP address of the IP gateway associated with the merchant and the IP address of the IP gateway associated with the customer conducting the transaction. Once the IP address is detected, the apparatus may determine if the IP address is in accordance with the one or more limits. In response to determining if the IP address is in accordance with the one or more limits, the apparatus may be configured to allow the transaction. On the other hand, if the IP address is not in accordance with the one or more limits, the apparatus may be configured to deny the transaction.

In response to applying the one or more limits to the token, as previously discussed, the system may be configured to transmit the token (or otherwise activate the stored token) to the user 2 with the applied one or more limits, as shown in block 88. This may comprise automatically uploading the token (or token information to access the token during a transaction) to the user's payment device 4 or authorizing the users 2 to download the token to the payment device 4. In one aspect, the system may transmit the token to the user 2 via a connection over the Internet or another communication medium using an application, an e-mail, text message, online banking account message, social media message, or other like message over another communication channel. As discussed the token may be associated directly with the payment device 4, with a digital wallet on the payment device, or through another application

FIG. 6B illustrates a process flow for limiting the use of a token based on a user location. In some embodiments, the apparatus may be configured to receive a payment authorization request associated with a transaction from a merchant 10, as shown in block 92. In one aspect, the payment authorization request includes transaction information, wherein the transaction is conducted using a token between a user and a merchant. In other embodiments of the invention the transaction information may be received in another way, such as from the payment device 4 of the user 2 or an application associated with the payment device 4. Additional transaction information may include at least one of a merchant location, a transaction amount, a product/service associated with the transaction, a time stamp of the transaction, token information, or the like.

In response to receiving the payment authorization request, the system may be configured to determine a response associated with the payment authorization request based on one or more limits, wherein the response is based on whether the user location associated with the transaction is within the one or more geographic limits associated with the token, as shown in block 94. In one aspect, the response includes permission authorizing the payment associated with the transaction request based on determining that the user location associated with the transaction lies within the geographic boundary associated with the token, as shown in block 95. In another aspect, the response includes a permission denying the payment authorization request based on determining that the user location associated with the transaction is not within the one or more geographic limits associated with the token, as shown in block 96.

In some embodiments, the payment authorization request is transmitted to the payment processing institutions (e.g., the tokenization service 50, the acquiring financial institution 20, the payment association networks 30, the issuing financial institution, or the like) by a transaction-processing device at a POS terminal associated with the merchant 10. In one aspect, the transaction processing device associated with the merchant 10 may be in the same location as the merchant. In another aspect, the transaction processing device associated with the merchant 10 may be in a different location relative to the location of the merchant 10. For example, instead of a POS terminal, the transaction processing device may be at least one e-commerce payment system capable of conducting a transaction via the Internet.

After determining the response associated with the payment authorization request, the system may be configured to transmit the response associated with the payment authorization to the merchant 10, as shown in block 98.

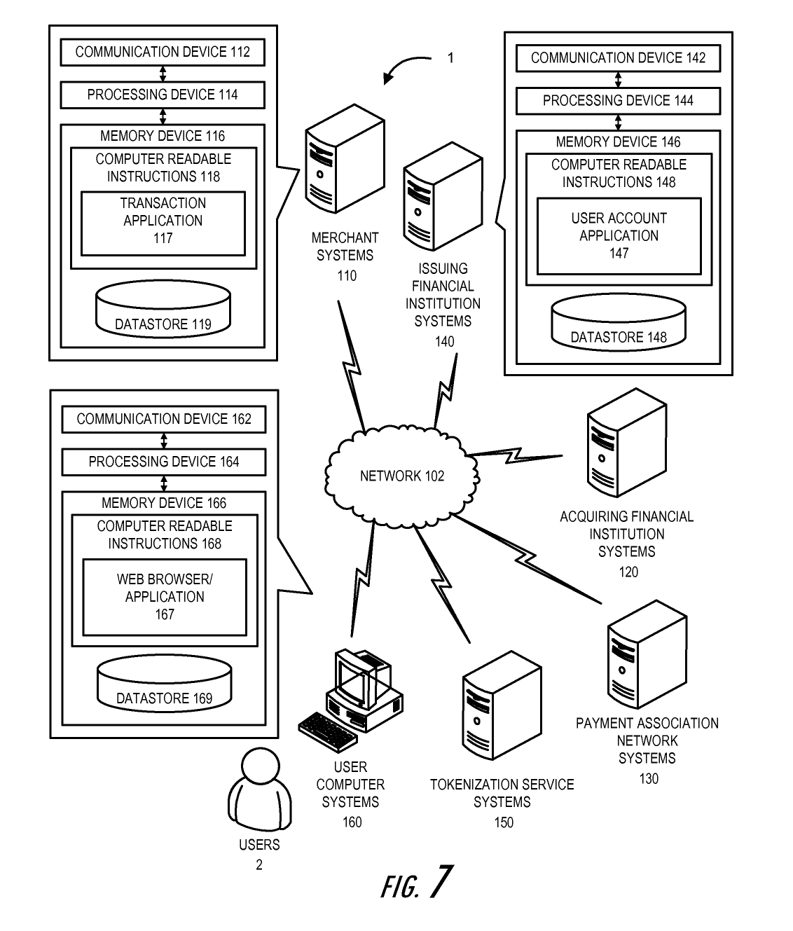

FIG. 7 illustrates a token system 100 environment, in accordance with an embodiment of the present invention. As illustrated in FIG. 7, the user computer systems 160 are operatively coupled, via a network 102 to the merchant systems 110, issuing financial institution systems 140, acquiring financial institution systems 120, payment association networks 130, and/or the tokenization service systems 150. In this way, the user 2 may utilize the user computer systems 160 to enter into secure transactions using a token with the merchant 10 through the use of the merchant systems 110, acquiring financial systems 120, payment association networks 130, the issuing financial institution systems 140, and/or the tokenization service systems 150. FIG. 7 illustrates only one example of embodiments of a token system 100, and it will be appreciated that in other embodiments one or more of the systems (e.g., computers, mobile devices, servers, or other like systems) may be combined into a single system or be made up of multiple systems.

The network 102 may be a global area network (GAN), such as the Internet, a wide area network (WAN), a local area network (LAN), or any other type of network or combination of networks. The network 102 may provide for wireline, wireless, or a combination of wireline and wireless communication between devices on the network.

As illustrated in FIG. 7, the user computer systems 160 generally comprise a communication device 162, a processing device 164, and a memory device 166. As used herein, the term “processing device” generally includes circuitry used for implementing the communication and/or logic functions of a particular system. For example, a processing device may include a digital signal processor device, a microprocessor device, and various analog-to-digital converters, digital-to-analog converters, and other support circuits and/or combinations of the foregoing. Control and signal processing functions of the system are allocated between these processing devices according to their respective capabilities. The processing device may include functionality to operate one or more software programs based on computer-readable instructions thereof, which may be stored in a memory device.

The processing device 164 is operatively coupled to the communication device 162 and the memory device 166. The processing device 164 uses the communication device 162 to communicate with the network 102 and other devices on the network 102, such as, but not limited to, the merchant systems 110, issuing financial institution systems 140, acquiring financial institution systems 120, payment association network systems 130, and/or tokenization service systems 150. As such, the communication device 162 generally comprises a modem, server, or other device for communicating with other devices on the network 102, and a display, camera, keypad, mouse, keyboard, microphone, and/or speakers for communicating with one or more users 102. The user computer systems 160 may include, for example, a payment device 4, which may be a personal computer, a laptop, a mobile device (e.g., phone, smartphone, tablet, or personal display device (“PDA”), or the like) or other like devices whether or not the devices are mentioned within this specification. In some embodiments, the user computer systems 160, such as a payment device 4, or other devices, could include a data capture device that is operatively coupled to the communication device, processing device 164, and the memory device 166. The data capture device could include devices such as, but not limited to a location determining device, such as a radio frequency identification (“RFID”) device, a global positioning satellite (“GPS”) device, Wi-Fi triangulation device, or the like, which can be used by a user 2, institution, or the like to capture information from a user 2, such as but not limited to the location of the user 2.

As further illustrated in FIG. 7, the user computer systems 160 comprises computer-readable instructions 168 stored in the memory device 166, which in one embodiment includes the computer-readable instructions 168 of a tokenization application 167 (e.g., a digital wallet or other application that utilizes tokens). In some embodiments, the memory device 166 includes a datastore 169 for storing data related to the user computer system 160, including but not limited to data created and/or used by tokenization application 167. As discussed above the tokenization application 167 allows the users 2 to enter into secure transactions using one or more tokens instead of customer account number or other customer information.

As further illustrated in FIG. 7, the merchant systems 110 generally comprise a communication device 112, a processing device 114, and a memory device 116. The processing device 114 is operatively coupled to the communication device 112 and the memory device 116. The processing device 114 uses the communication device 112 to communicate with the network 102, and other devices on the network 102, such as, but not limited to, the user computer systems 160, issuing financial institution systems 140, acquiring financial institution systems 120, payment association network systems 130, and/or the tokenization service systems 150. As such, the communication device 112 generally comprises a modem, server, or other device(s) for communicating with other devices on the network 102.

As illustrated in FIG. 7, the merchant systems 110 comprise computer-readable program instructions 118 stored in the memory device 116, which in one embodiment includes the computer-readable instructions 118 of a transaction application 117. In some embodiments, the memory device 116 includes a datastore 119 for storing data related to the merchant systems 110, including but not limited to data created and/or used by the transaction application 117. The transaction application 117 processes transactions with the user regardless of whether or not the user is using tokens or the actual account number or other account information.

As further illustrated in FIG. 7, the issuing financial institution systems 140 generally comprise a communication device 142, a processing device 144, and a memory device 146. The processing device 144 is operatively coupled to the communication device 142 and the memory device 146. The processing device 144 uses the communication device 142 to communicate with the network 102, and other devices on the network 102, such as, but not limited to, the user computer systems 160, merchant systems 110, acquiring financial institution systems 120, payment association network systems 130, and/or the tokenization service systems 150. As such, the communication device 142 generally comprises a modem, server, or other devices for communicating with other devices on the network 102.

As illustrated in FIG. 7, the issuing financial institution systems 140 comprise computer-readable program instructions 148 stored in the memory device 146, which in one embodiment includes the computer-readable instructions 148 of a user account application 147. In some embodiments, the memory device 146 includes a datastore 149 for storing data related to the issuing financial institution systems 140, including but not limited to data created and/or used by the user account application 147. The user account application 147 allows the issuing financial institution to store information regarding the user accounts. For example, in the embodiments in which the issuing financial institution 40 is responsible for managing the tokenization, the user account application 147 stores the tokens associated with the account number or the other customer information, which the users 2 utilize to enter into transactions. In other embodiments of the invention, the association of the tokens and accounts numbers and other account information from the issuing financial institution 40 may be stored by a third party.

The acquiring financial institution systems 120 are operatively coupled to the user computer systems 160, merchant systems 110, payment association network systems 130, issuing financial institutions 140, or tokenization service systems 150 through the network 102. The acquiring financial institution systems 120 have devices that are the same as or similar to the devices described for the user computer systems 160, merchant systems 110, or the issuing financial institution systems 140 (e.g., communication device, processing device, memory device with computer-readable instructions, datastore, or the like). Thus, the acquiring financial institution systems 120 communicate with the user computer systems 160, merchant systems 110, payment association network systems 130, issuing financial institution systems 140, and/or the tokenization service systems 150, in the same or similar way as previously described with respect to these systems above. The acquiring financial institution systems 120, in some embodiments, receives the tokens and/or other customer information, along with the transactions information for a transaction, from the merchants 10 and distributes this information to the proper tokenization service 50, payment association networks 30, or directly the issuing financial institution 40.

The payment association network systems 130 are operatively coupled to the user computer systems 160, merchant systems 110, acquiring financial institution systems 120, issuing financial institutions 140, or tokenization service systems 150 through the network 102. The payment association network systems 130 have devices that are the same as or similar to the devices described for the user computer systems 160, merchant systems 110, or the issuing financial institution systems 140 (e.g., communication device, processing device, memory device with computer-readable instructions, datastore, or the like). Thus, the payment association network systems 130 communicate with the user computer systems 160, merchant systems 110, acquiring financial institution systems 120, issuing financial institution systems 140, and/or the tokenization service systems 150, in the same or similar way as previously described with respect to these systems above. The payment association networks systems 130, in some embodiments, receive the tokens and/or other customer information, along with the transactions information for a transaction, from the merchants 10 or the acquiring financial institution 20, and distribute this information to the proper issuing financial institution 40.

The tokenization service systems 150 are operatively coupled to the user computer systems 160, merchant systems 110, acquiring financial institution systems 120, or issuing financial institutions 140 through the network 102. The tokenization service systems 150 have devices the same or similar to the devices described for the user computer systems 160, merchant systems 110, or the issuing financial institution systems 140 (e.g., communication device, processing device, memory device with computer-readable instructions, datastore, or the like). Thus, the tokenization service systems 150 communicate with the user computer systems 160, merchant systems 110, acquiring financial institution systems 120, and/or issuing financial institution systems 140, in the same or similar way as previously described with respect to the these systems above. The tokenization service systems 150, in some embodiments, create, associate, and store the tokens, account numbers, and/or other customer information in order to shield the account numbers or other customer account information from the merchants 10, and other parties as described throughout this specification. In some embodiments as illustrated in FIG. 1, the tokenization service systems 150 may be operated by a third party entity. In other embodiments the tokenization service systems 150 may be operated by the issuing financial institution 40 or entity associated with the issuing financial institution 40, such that only the issuing financial institution 40 has access to the actual account number or other account information.

It is understood that the systems and devices described herein illustrate one embodiment of the invention. It is further understood that one or more of the systems, devices, or the like can be combined or separated in other embodiments and still function in the same or similar way as the embodiments described herein.

Any suitable computer-usable or computer-readable medium may be utilized. The computer usable or computer readable medium may be, for example but not limited to, an electronic, magnetic, optical, electromagnetic, infrared, or semiconductor system, apparatus, or device. More specific examples (a non-exhaustive list) of the computer-readable medium would include the following: an electrical connection having one or more wires; a tangible medium such as a portable computer diskette, a hard disk, a random access memory (RAM), a read-only memory (ROM), an erasable programmable read-only memory (EPROM or Flash memory), a compact disc read-only memory (CD-ROM), or other tangible optical or magnetic storage device.

Computer program code/computer-readable instructions for carrying out operations of embodiments of the present invention may be written in an object oriented, scripted or unscripted programming language such as Java, Pearl, Smalltalk, C++ or the like. However, the computer program code/computer-readable instructions for carrying out operations of the invention may also be written in conventional procedural programming languages, such as the “C” programming language or similar programming languages.

Embodiments of the present invention described above, with reference to flowchart illustrations and/or block diagrams of methods or apparatuses (the term “apparatus” including systems and computer program products), will be understood to include that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a particular machine, such that the instructions, which execute via the processor of the computer or other programmable data processing apparatus, create mechanisms for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer readable memory produce an article of manufacture including instructions, which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions, which execute on the computer or other programmable apparatus, provide steps for implementing the functions/acts specified in the flowchart and/or block diagram block or blocks. Alternatively, computer program implemented steps or acts may be combined with operator or human implemented steps or acts in order to carry out an embodiment of the invention.

While certain exemplary embodiments have been described and shown in the accompanying drawings, it is to be understood that such embodiments are merely illustrative of, and not restrictive on, the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations, modifications, and combinations of the just described embodiments can be configured without departing from the scope and spirit of the invention. Therefore, it is to be understood that, within the scope of the appended claims, the invention may be practiced other than as specifically described herein.

To supplement the present disclosure, this application further incorporates entirely by reference the following commonly assigned patent applications:

| | U.S. | | |
|---|---|---|---|
| | patent | | |
| Docket | application | | Filed |
| Number | Ser. No. | Title | On |
| 6070US1. | | MANAGED | Concurrently |
| 014033.2138 | | DIGITAL | Herewith |
| | | WALLETS | |
| 6071US1. | | TOKEN | Concurrently |
| 014033.2153 | | COLLABORATION | Herewith |
| | | NETWORK | |
| 6071US2. | | FORMATION AND | Concurrently |
| 014033.2154 | | FUNDING OF A | Herewith |
| | | SHARED TOKEN | |
| 6072US1. | | LIMITING TOKEN | Concurrently |
| 014033.2151 | | COLLABORATION | Herewith |
| | | NETWORK | |
| | | USAGE BY USER | |
| 6072US2. | | LIMITING TOKEN | Concurrently |
| 014033.2152 | | COLLABORATION | Herewith |
| | | NETWORK | |
| | | USAGE BY TOKEN | |
| 6073US2. | | AUTHORIZING A | Concurrently |
| 014033.2150 | | TEMPORARY | Herewith |
| | | TOKEN | |
| | | FOR A USER | |
| 6074US1. | | CONTROLLING TOKEN | Concurrently |
| 014033.2148 | | ISSUANCE BASED ON | Herewith |
| | | EXPOSURE | |
| 6075US1. | | FLEXIBLE | Concurrently |
| 014033.2146 | | FUNDING ACCOUNT | Herewith |
| | | TOKEN | |
| | | ASSOCIATIONS | |
| 6075US2. | | ACCOUNT TOKEN | Concurrently |
| 014033.2147 | | ASSOCIATIONS | Herewith |
| | | BASED ON | |
| | | SPENDING | |
| | | THRESHOLDS | |
| 6076US1. | | ONLINE BANKING | Concurrently |
| 014033.2144 | | DIGITAL WALLET | Herewith |
| | | MANAGEMENT | |
| 6076US2. | | CUSTOMER TOKEN | Concurrently |
| 014033.2145 | | PREFERENCES INTERFACE | Herewith |
| 6076US3. | | CREDENTIAL PAYMENT | Concurrently |
| 014033.2172 | | OBLIGATION VISIBILITY | Herewith |
| 6077US1. | | PROVIDING | Concurrently |
| 014033.2143 | | SUPPLEMENTAL | Herewith |
| | | ACCOUNT INFORMATION | |
| | | IN DIGITAL WALLETS | |
| 6078US1. | | PROVIDING OFFERS | Concurrently |
| 014033.2142 | | ASSOCIATED WITH | Herewith |
| | | PAYMENT | |
| | | CREDENTIALS IN | |
| | | DIGITAL | |
| | | WALLETS | |
| 6078US2. | | PROVIDING OFFERS | Concurrently |
| 014033.2179 | | ASSOCIATED | Herewith |
| | | WITH PAYMENT | |
| | | CREDENTIALS | |
| | | AUTHENTICATED | |
| | | IN A SPECIFIC | |
| | | DIGITAL WALLET | |
| 6079US1. | | FOREIGN EXCHANGE | Concurrently |
| 014033.2141 | | TOKEN | Herewith |
| 6079US2. | | FOREIGN CROSS-ISSUED | Concurrently |
| 014033.2173 | | TOKEN | Herewith |
| 6080US1. | | DIGITAL WALLET | Concurrently |
| 014033.2140 | | EXPOSURE REDUCTION | Herewith |
| 6080US2. | | MOBILE DEVICE | Concurrently |
| 014033.2174 | | CREDENTIAL | Herewith |
| | | EXPOSURE REDUCTION | |
| 6081US1. | | ATM TOKEN CASH | Concurrently |
| 014033.2139 | | WITHDRAWAL | Herewith |
| 014033. | | RESTORING OR | Concurrently |
| 002194 | | REISSUING OF | Herewith |
| | | A TOKEN BASED ON USER | |
| | | AUTHENTICATION | |
| 014033. | | TOKEN USAGE | Concurrently |
| 002195 | | SCALING BASED | Herewith |
| | | ON DETERMINED | |
| | | LEVEL OF EXPOSURE | |

What is claimed is:

1. A system for use in a token based financial transaction system, whereby a token associated with a financial account is utilized by a user to enter into a financial transaction, and whereby the use of the token is limited based on a user location, the system comprising:
a memory device; and
a processing device operatively coupled to the memory device, wherein the processing device is configured to execute computer-readable program code to:
receive a payment authorization request associated with the financial transaction from a merchant, wherein the payment authorization request comprises transaction information associated with the financial transaction, wherein the financial transaction is conducted using the token between the user and the merchant, wherein the payment authorization request comprises the user location associated with the financial transaction;
determine a response associated with the payment authorization request, wherein the response is based on the one or more limits associated with the token used to conduct the financial transaction, wherein the one or more limits are based on at least a geographic limit associated with the use of the token;
authorize a payment associated with the payment transaction request when the transaction information meets the one or more limits, including when at least the user location associated with the financial transaction meets the geographic limit associated with the use of the token;
deny a payment associated with the payment transaction request when the transaction information fails to meet the one or more limits, including when at least the user location associated with the financial transaction fails to meet the geographic limit associated with the use of the token; and
transmit the response associated with the payment authorization request to the merchant.

2. The system of claim 1, wherein the geographic limit comprises a boundary defined by a geographic radius associated with a location.

3. The system of claim 1, wherein the geographic limits is based on a transportation route.

4. The system of claim 1, wherein the user location is determined from a location of a payment device associated with the token at a same or similar time stamp associated with the transaction, wherein the location of the payment device is an indication of a location of the user.

5. The system of claim 1, wherein the user location is determined from the transaction information.

6. The system of claim 1, wherein the token is associated with the financial account is associated with two or more financial accounts associated with the user.

7. The system of claim 6, wherein the system enables a user selection of the two or more financial institution accounts associated with the token.

8. The system of claim 1, wherein the token is associated with one or more digital wallets on one or more payment devices associated with a plurality of users.

9. The system of claim 8, wherein the token is a shared token and the user is part of a collaborative group of users, and wherein the shared token is used by the collaborative group of users.

10. The system of claim 1, wherein the token is an individual token for the user in a collaborative group of users.

11. The system of claim 1, wherein the one or more limits are further based on at least a time period, wherein the response is based on whether a time stamp associated with the transaction is within the time period.

12. The system of claim 1, wherein the one or more limits further comprises a number of transactions, a transaction amount, a merchant, a merchant type, a product, a product type, one or more product categories, or an account limit.

13. A computer program product for use in a token based financial transaction system, whereby a token associated with a financial account is utilized by a user to enter into a financial transaction, and whereby the use of the token is limited based on a user location, the computer program product comprising at least one non-transitory computer-readable medium having a computer-readable program code portions embodied therein, the computer-readable program code portions comprising:
an executable portion configured for receiving a payment authorization request associated with the financial transaction from a merchant, wherein the payment authorization request comprises transaction information associated with the financial transaction, wherein the financial transaction is conducted using the token between the user and the merchant, wherein the payment authorization request comprises the user location associated with the financial transaction;
an executable portion configured for determining a response associated with the payment authorization request, wherein the response is based on the one or more limits associated with the token used to conduct the financial transaction, wherein the one or more limits are based on at least a geographic limit associated with a use of the token;
an executable portion configured for authorizing a payment associated with the payment transaction request when the transaction information meets the one or more limits, including when at least the user location associated with the financial transaction meets the geographic limit associated with the use of the token;
an executable portion configured for denying a payment associated with the payment transaction request when the transaction information fails to meet the one or more limits, including when at least the user location associated with the financial transaction fails to meet the geographic limit associated with the use of the token; and
an executable portion configured for transmitting the response associated with the payment authorization request to the merchant.

14. The computer program product of claim 13, wherein the geographic limit comprises a boundary defined by a geographic radius associated with a location.

15. The computer program product of claim 13, wherein the geographic limit is based on a transportation route.

16. The computer program product of claim 13, wherein the user location is determined from a location of a payment device associated with the token at a same or similar time stamp associated with the transaction, wherein the location of the payment device is an indication of a location of the user.

17. The computer program product of claim 13, wherein the user location is determined from the transaction information.

18. The computer program product of claim 13, wherein the token is associated with one or more digital wallets on one or more payment devices associated with a plurality of users, and wherein the token is a shared token and the user is part of a collaborative group of users, and wherein the shared token is used by the collaborative group of users.

19. The computer program product of claim 13, wherein the token is an individual token for the user in a collaborative group of users.

20. A method for use in a token based financial transaction system, whereby a token associated with a financial account is utilized by a user to enter into a financial transaction, and whereby the use of the token is limited based on a user location, the method comprising:
receiving, using a computing device processor, a payment authorization request associated with the financial transaction from a merchant, wherein the payment authorization request comprises transaction information associated with the financial transaction, wherein the financial transaction is conducted using the token between the user and the merchant, wherein the payment authorization request comprises the user location associated with the financial transaction;
determining, using a computing device processor, a response associated with the payment authorization request, wherein the response is based on the one or more limits associated with the token used to conduct the financial transaction, wherein the one or more limits are based on at least a geographic limit associated with a use of the token;
authorizing, using a computing device processor, a payment associated with the payment transaction request when the transaction information meets the one or more limits, including when at least the user location associated with the financial transaction meets the geographic limit associated with the use of the token;
denying, using a computing device processor, a payment associated with the payment transaction request when the transaction information fails to meet the one or more limits, including when at least the user location associated with the financial transaction fails to meet the geographic limit associated with the use of the token; and
transmitting, using a computing device processor, the response associated with the payment authorization request to the merchant.
